(19) United States
(12) Patent Application Publication
(10) Pub. No.: US 2008/0033826 A1
(43) Pub. Date: Feb. 7, 2008

(54) Personality-based and mood-base provisioning of advertisements

(75) Inventors: Ariel Maislos, Sunnyvale, CA (US); Ruben Maislos, Or-Yehuda (IL); Eran Arbel, Cupertino, CA (US)

Correspondence Address: DR. MARK FRIEDMAN LTD.;C/o Bill Polkinghorn, 9003 Florin Way, Upper Marlboro, MD, 20772, US

(73) Assignee: Pudding Ltd.

(21) Appl. No.: 11/882,489

(22) Filed: Aug. 2, 2007

Related U.S. Application Data
(60) Provisional application No. 60/821,271, filed on Aug. 3, 2006.

(51) Int. Cl. G06Q 30/00; G06F 17/30

(52) U.S. Cl. 705/14

(57) ABSTRACT

Methods, apparatus and computer-code for electronically providing advertisement are disclosed herein. In some embodiments, advertisements are provided in accordance with at least one feature personality trait and/or at least one mood deviation feature. Optionally, the aforementioned personality trait and/or mood deviation feature are computed over a “long time”—for example, at least day-separated distinct multi-party conversations.

### CROSS-REFERENCE TO RELATED APPLICATIONS

This patent application claims the benefit of U.S. Provisional Patent Application No. 60/821,271 filed Aug. 3, 2006 by the present inventors.

### FIELD OF THE INVENTION

The present invention relates to techniques for facilitating advertising in accordance with electronic media content, such as electronic media content of a multi-party conversation.

### BACKGROUND AND RELATED ART

With the growing number of Internet users, advertisements using the Internet (Internet advertisements) are becoming increasingly popular. To date, various on-line service providers (for example, content providers and search engines) serve internet advertisements to users (for example, to a web browser residing on a user's client device) who receive the advertisement when accessing the provided services.

One effect of Internet-based advertisement is that it provides revenue for providers of various Internet-based services, allowing the service-provider to obtain revenue and ultimately lowering the price of Internet-based services for users. It is known that many purchasers of advertisements wish to ‘target’ their advertisements to specific groups that may be more receptive to certain advertisements.

Thus, targeted advertisement provides opportunities for all—for users who receive more relevant advertisements and are not ‘distracted’ by marginally-relevant advertisements and who also are able to benefit from at least partially advertisement-supported service; for service providers who have the opportunity to provide advertisement-supported advertisements; and for advertisers who may more effectively use their advertisement budget.

Because targeted advertisement can provide many benefits, there is an ongoing need for apparatus, methods and computer code which provide improved targeted advertisements.

The following published patent applications provide potentially relevant

background material: US 2006/0167747; US 2003/0195801; US 2006/0188855; US 2002/0062481; and US 2005/0234779.

All references cited herein are incorporated by reference in their entirety. Citation of a reference does not constitute an admission that the reference is prior art.

### SUMMARY OF THE INVENTION

According to some embodiments of the present invention, a method of facilitating advertising is provided. The method comprises the steps of: a) providing electronic media content of at least one multi-party voice conversation (i.e. including spoken content of the conversation and optionally video content); and b) in accordance with a personality profile for a given conversation party, indicated by the electronic media content (i.e. according to a given set of criteria), providing at least one advertisement.

For the present disclosure, a ‘personality-profile’ refers to a detected (i.e. from the electronic media content) presence or absence of one or more ‘personality traits.’ Typically, each personality trait is determined beyond a given ‘certainty parameter’ (i.e. at least 90% certain, at least 95% certain, etc). This may be carried out using, for example, a classification model for classifying the presence or absence of the personality trait(s), and the ‘personality trait certainty’ parameter may be computed, for example, using some ‘test set’ of electronic media content of a conversation between people of known personality.

The determination of whether or not a given conversation party (i.e. someone participating in the multi-party conversation that generates voice content and optionally video or other audio content) has a given ‘personality trait(s)’ may be carried out in accordance with one or more ‘features’ of the multi-party conversation.

Some features may be ‘positive indicators.’ For example, a given individual may speak loudly, or talk about himself, and these features may be considered positive indicators that the person is ‘extroverted.’ It is appreciated that not every loud-spoken individual is necessarily extroverted. Thus, other features may be ‘negative indicators’ for example, a person's body language (an extroverted person is likely to make eye-contact, and someone who looks down when speaking is less likely to be extroverted—this may be a negative indicator). In different embodiments, the set of ‘positive indicators’ (i.e. the positive feature set) may be “weighed” (i.e. according to a classification model) against a set of ‘negative indicators’ to classify a given individual as ‘having’ or ‘lacking’ a given personality trait, with a given certainty. It is understood that more positive indicators and fewer negative indicators for a given personality trait for an individual would allow a hypothesis that the individual ‘has’ the personality trait to be accepted with a greater certainty or ‘hurdle.’

In another example, a given feature (i.e. feature “A”) is only indicative of a given personality trait (i.e. trait “X”) if the feature appears in combination with a different feature (i.e. feature “B”). Different models designed to minimize the number of false positives and false negatives may require a presence or absence of certain combinations of “features” in order to accept or reject a given personality trait presence or absence hypothesis.

According to some embodiments, the aforementioned personality-profile-dependent providing is contingent on a positive feature set of at least one feature of the electronic media content for the personality profile, outweighing a negative feature set of at least one feature of the electronic media content for the personality profile, according to a training set classifier model.

According to some embodiments, at least one feature of at least one of the positive and the negative feature set is a video content feature (for example, an ‘extrovert’ may make eye contact with a co-conversationalist).

According to some embodiments, at least one feature of at least one of the positive and the negative feature set is a key words feature (for example, a person may say “I am angry” or “I am happy”).

According to some embodiments, at least one feature of at least one of the positive and the negative feature set is a speech delivery feature (for example, speech loudness, speech tempo, voice inflection (i.e. is the person a ‘complainer’ or not), etc).

Another exemplary speech delivery feature is a inter-party speech interruption feature—i.e. does an individual interrupt others when they speak or not.

According to some embodiments at least one feature of at least one of the positive and the negative feature set is a physiological parameter feature (for example, a breathing parameter (an exited person may breath faster, or an alcoholic may breath faster when viewing alcohol), a sweat parameter (a nervous person may sweat more than a relaxed person)).

According to some embodiments, at least one feature of at least one of the positive and the negative feature set includes at least one background feature selected from the group consisting of: i) a background sound feature (i.e. an introverted person would be more likely to be in a quiet room on a regular basis); and ii) a background image feature (i.e. a messy person would have a mess in his room and this would be visible in a video conference).

According to some embodiments, at least one feature of at least one of the positive and the negative feature set if selected from the group consisting of: i) a typing biometrics feature; ii) a clicking biometrics feature (for example, a ‘hyperactive person’ would click quickly); and iii) a mouse biometrics feature (for example, one with attention-deficit disorder would rarely leave his or her mouse in one place).

According to some embodiments, at least one feature of at least one of the positive and the negative feature set is an historical deviation feature (i.e. comparing user behavior at one point in time with another point in time—this could determine if a certain behavior is indicative of a transient mood or a user personality trait).

According to some embodiments, at least the historical deviation feature is an intra-conversation historical deviation feature (i.e. comparing user behavior in different conversations—for example, separated in time by at least a day).

According to some embodiments, i) the at least one multi-party voice conversation includes a plurality of distinct conversations; ii) at least one historical deviation feature is an inter-conversation historical deviation feature for at least two of the plurality of distinct conversations.

According to some embodiments, i) the at least one multi-party voice conversation includes a plurality of at least day-separated distinct conversations; ii) at least one historical deviation feature is an inter-conversation historical deviation feature for at least two of the plurality of at least day-separated distinct conversations.

According to some embodiments, at least the historical deviation feature includes at least one speech delivery deviation feature selected from the group consisting of: i) a voice loudness deviation feature; ii) a speech rate deviation feature.

According to some embodiments, at least the historical deviation feature includes a physiological deviation feature (for example, is a user's breathing rate consistent, or are there deviations—an excitable person is more likely to have larger fluctuations in breathing rate).

As noted before, different models for classifying people according to their personalities may examine a combination of features, and in order to reduce errors, certain combinations of features may be required in order to classify a person has “having” or “lacking” a personality trait.

Thus, according to some embodiments, the personality-profile-dependent providing is contingent on a feature set of the electronic media content satisfying a set of criteria associated with the personality profile, wherein: i) a presence of a first feature of the feature set without a second feature the feature set is insufficient for the electronic media content to be accepted according to the set of criteria for the personality profile; ii) a presence of the second feature without the first feature is insufficient for the electronic media content to be accepted according to the set of criteria for the personality profile; iii) a presence of both the first and second features is sufficient (i.e. for classification) according to the set of criteria. In the above example, both the “first” and “second” features are “positive features”—appearance of just one of these features is not “strong enough” to classify the person and both features are required.

In another example, the “first” feature is a “positive” feature and the “second” feature is a “negative” feature. Thus, in some embodiments, the personality-profile-dependent providing is contingent on a feature set of the electronic media content satisfying a set of criteria associated with the personality profile, wherein: i) a presence of both a first feature of the feature set and a second feature the feature set necessitates the electronic media content being rejected according to the set of criteria for the personality profile; ii) a presence of the first feature without the second feature allows the electronic media content to be accepted according to the set of criteria for the personality profile.

It is recognized that it may take a certain amount of minimum time in order to reach meaningful conclusions about a person's personality traits, and distinguish behavior indicative of transient moods with behavior indicative of personality traits. Thus, in some embodiments, i) the at least one multi-party voice conversation includes a plurality of distinct conversations; ii) the first feature is a feature is a first the conversation of the plurality of distinct conversations; iii) the second feature is a second the conversation of the plurality of distinct conversations.

According to some embodiments, i) the at least one multi-party voice conversation includes a plurality of at least day-separated distinct conversations; ii) the first feature is a feature is a first the conversation of the plurality of distinct conversations; iii) the second feature is a second the conversation of the plurality of distinct conversations; iv) the first and second conversations are at least day-separated conversations.

According to some embodiments, the providing electronic media content includes eavesdropping on a conversation transmitted over a wide-range telecommunication network.

According to some embodiments, the personality profile is a long-term personality profile (i.e. derived from a plurality of distinct conversations that transpire over a ‘long’ period of time—for example, at least a week or at least a month). According to some embodiments, the advertisement-providing is in accordance with a certainty parameter (i.e. that can adopt one of many values between 0% certainty and 100% certainty) of the personality profile. Thus, in one example, a first vendor wants to serve advertisement for sky-diving trips only to those where it is at least 99% certain that a person is ‘adventurous.’ In another example, a second vendor may serve advertisement to an ‘adventure movie’ and require a lower level of certainty about the target's adventurousness—for example, at least 60% certainty.

Thus, in some embodiments the ‘providing’ is carried out in accordance with a ‘certainty parameter’ for classifying a person/conversation party is having or lacking a personality trait or traits. Furthermore, in some embodiments, the pricing of the service of distributing such an advertisement (i.e. in accordance with a classified personality trait(s)) is carried out in accordance with a certainty parameter. Thus, in one example, the cost per ad served for an advertisement where it is 95% certain that a person has a given personality trait exceeds the cost per ad served for an advertisements where it is only 80% certain that the person has the given personality trait.

There are different ways in which an advertisement may be ‘provided’ in accordance with a personality provide.

In one example, the personality-profile-dependent-advertisement-providing includes selecting an advertisement from a pre-determined pool of advertisements in accordance with the personality-profile.

In another example, the personality-profile-dependent-advertisement-providing includes customizing a pre-determined advertisement in accordance with the personality profile. Thus, in one example, the price for a certain item may be higher for more arrogant or boastful individuals. In another example, a car may be advertised in red for me extroverted or dominant individuals, and in black or dark blue for more introverted individuals.

According to some embodiments, the personality-profile-dependent-advertisement-providing includes modifying an advertisement mailing list in accordance with the personality profile.

According to some embodiments, the personality-profile-dependent-advertisement-providing includes configuring a client device to present at least one advertisement in accordance with the personality profile.

According to some embodiments, personality-profile-dependent-advertisement-providing includes determining an ad residence time in accordance with the personality profile. Thus, if it assessed from the digital media content of the multi-person conversation that a person is impatient, the residence time may be shorter than the situation where it is determined that the person is patient.

According to some embodiments, personality-profile-dependent-advertisement-providing includes determining an ad switching rate in accordance with the personality profile.

According to some embodiments, the personality-profile-dependent-advertisement-providing includes determining an ad size parameter rate in accordance with the personality profile.

According to some embodiments, the personality-profile-dependent-advertisement-providing includes presenting at least one acquisition condition parameter (for example, a price or an expiration date of a sale) whose value is determined in accordance with the personality profile.

According to some embodiments, the at least one acquisition condition parameter is selected from the group consisting of: i) a price parameter and ii) an offered-item time-interval parameter.

According to some embodiments, the method further comprises: c) receiving a specification of the personality-profile (for example, via a personality-advertisement data-receiving user interface); and d) receiving a certainty parameter associated with the personality-profile, wherein the personality-profile-dependent-advertisement-providing is carried out in accordance with the certainty parameter (i.e. the greater the ‘certainty parameter,’ the greater a signal/noise ratio required—thus, the certainty parameter may act as a ‘noise filter’).

It is now disclosed for the first time a method of facilitating advertising, the method comprising: a) providing electronic media content of at least one multi-party voice conversation (i.e. including spoken content of the conversation and optionally video content); b) in accordance with a personality-trait-exhibition-incident occurrence-frequency for a given conversation party, indicated by the electronic media content (i.e. according to a given set of criteria), providing at least one advertisement.

It is now disclosed for the first time a method of facilitating advertising, the method comprising: a) providing electronic media content of at least one multi-party voice conversation (i.e. including spoken content of the conversation and optionally video content); b) in accordance with a mood deviation for a given conversation party, indicated by the electronic media content (i.e. including spoken content of the conversation and optionally video content), providing at least one advertisement.

It is now disclosed for the first time an apparatus useful for facilitating advertising, the apparatus comprising: a) a data storage operative to store electronic media content of a multi-party voice conversation including spoken content of the conversation; and b) a data presentation interface operative to present at least one advertisement in accordance with a personality profile for a given conversation party, indicated by the electronic media content.

It is now disclosed for the first time an apparatus useful for facilitating advertising, the apparatus comprising: a) a data storage operative to store electronic media content of a multi-party voice conversation including spoken content of the conversation; and b) a data presentation interface operative to present at least one advertisement in accordance with a personality-trait-exhibition-incident occurrence-frequency for a given conversation party, indicated by the electronic media content.

It is now disclosed for the first time an apparatus useful for facilitating advertising, the apparatus comprising: a) a data storage operative to store electronic media content of a multi-party voice conversation including spoken content of the conversation; and b) a data presentation interface operative to present at least one advertisement in accordance with a mood deviation for a given conversation party, indicated by the electronic media content

It is now disclosed for the first time a method of facilitating advertising, the method comprising: a) receiving a directive to distribute advertisement content to users of a telecommunications service where a plurality of users communicate with each other via a telecommunications channel linking the plurality of users, thereby generating electronic media content; b) providing an advertisement service where the advertisement content is distributed to each user of a plurality of the telecommunications-service users in accordance with a respective personality profile of the each user indicated by respective the telecommunications-channel-communicated electronic media content generated by the each user.

According to some embodiments, the method further comprises: c) receiving a specification of a personality profile from a provider of the directive to distribute advertisement content.

According to some embodiments, the method further comprises: c) receiving a specification of at least one personality-trait certainty profile associated with the personality profile, wherein the personality-profile-dependent providing is carried out in accordance with the personality-trait certainty parameter.

According to some embodiments, the method further comprises: c) pricing advertisement distribution of the advertisement service in accordance with the personality profile.

These and further embodiments will be apparent from the detailed description and examples that follow.

### BRIEF DESCRIPTION OF THE DRAWINGS

While the invention is described herein by way of example for several embodiments and illustrative drawings, those skilled in the art will recognize that the invention is not limited to the embodiments or drawings described. It should be understood that the drawings and detailed description thereto are not intended to limit the invention to the particular form disclosed, but on the contrary, the invention is to cover all modifications, equivalents and alternatives falling within the spirit and scope of the present invention. As used throughout this application, the word “may” is used in a permissive sense (i.e., meaning “having the potential to”), rather than the mandatory sense (i.e. meaning “must”).

FIGS. 1-3 describe exemplary use scenarios.

FIG. 4-6 provides flow charts of exemplary techniques for facilitating advertising.

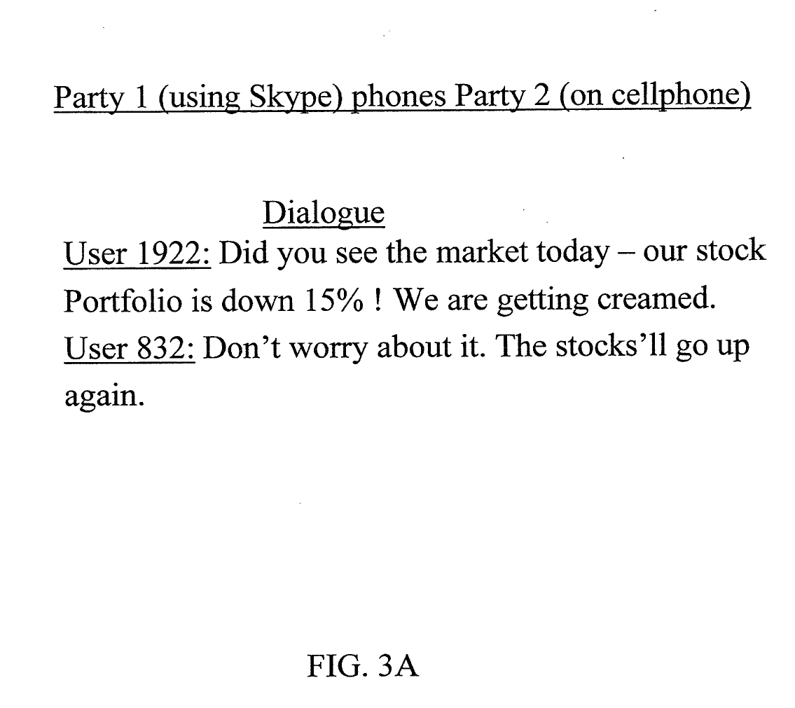

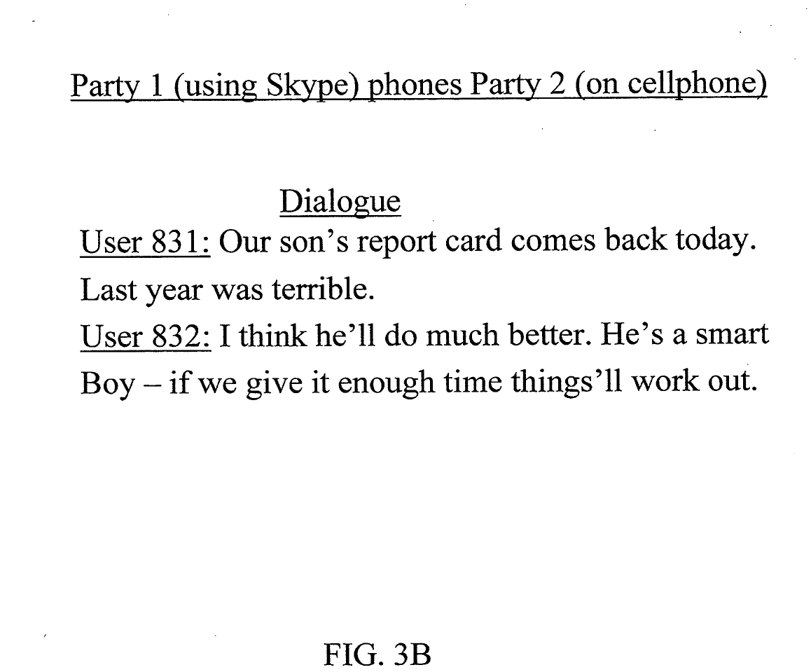

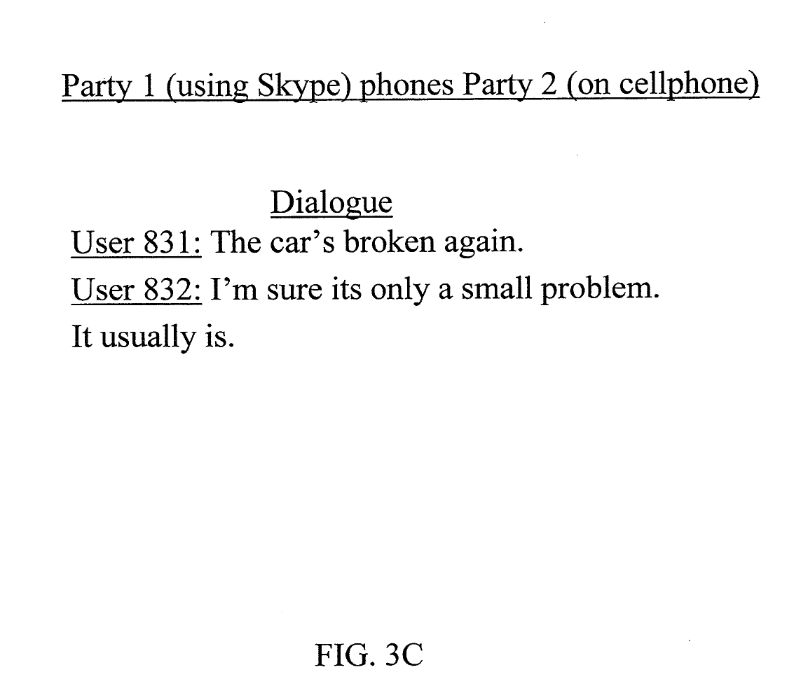

FIG. 3 describes an exemplary technique for computing one or more features of electronic media content including voice content.

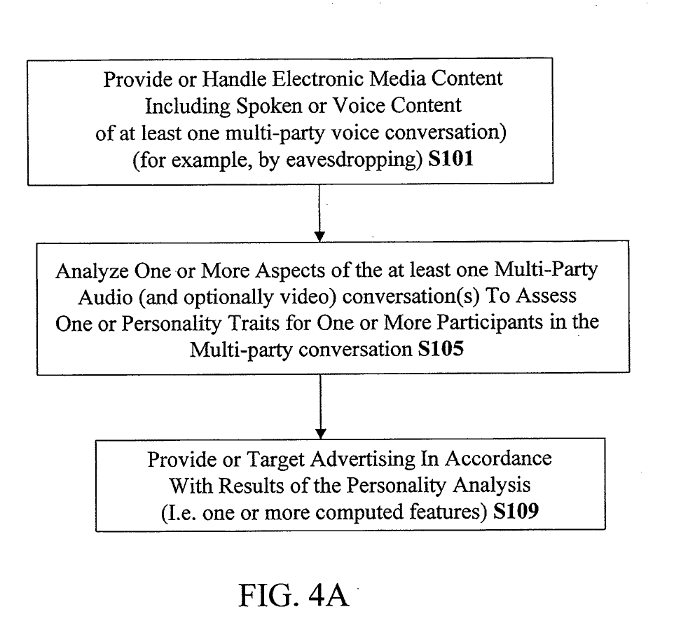

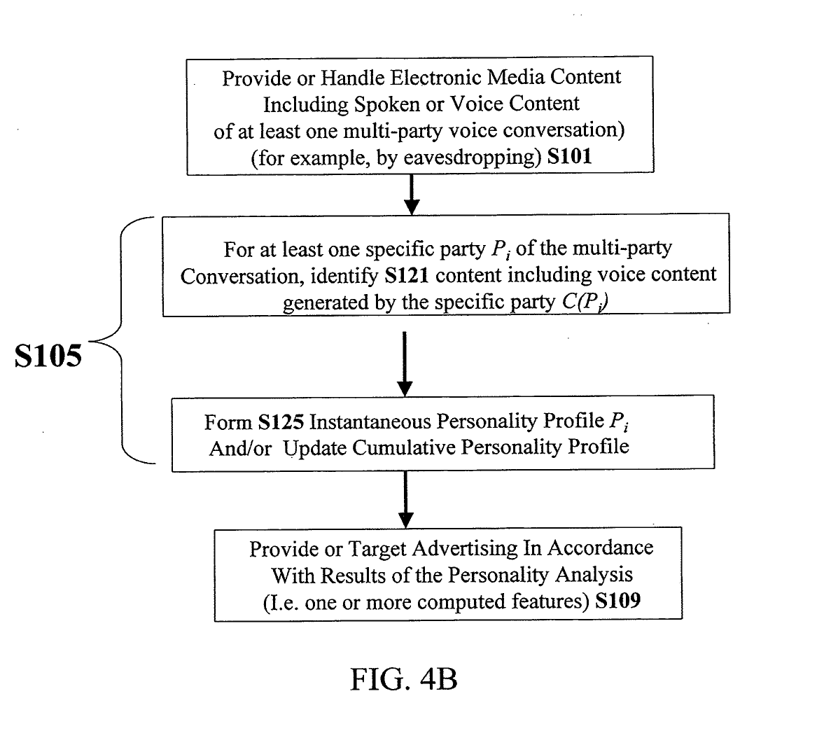

FIG. 4-6, 7B, 8 describes exemplary techniques for targeting advertisement.

FIG. 7A depicts and exemplary personality-advertisement data-receiving user interface.

FIG. 10 describes an exemplary system for providing a multi-party conversation.

FIGS. 11-16 describes exemplary systems for computing various features.

FIG. 17 describes components of an exemplary system for targeting advertisement.

### DETAILED DESCRIPTION OF EMBODIMENTS

The present invention will now be described in terms of specific, example embodiments. It is to be understood that the invention is not limited to the example embodiments disclosed. It should also be understood that not every feature of the presently disclosed apparatus, device and computer-readable code for facilitating advertising is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

The present inventors are now disclosing that it is useful to extract mood and/or personality data from digital media content (i.e. audio and/or video) and to target advertising content to one or more individuals associated with one or more ‘speaking parties’ of the digital media content in accordance with the extracted mood and/or personality data.

Embodiments of the present invention relate to a technique for provisioning advertisements in accordance with the context and/or content of voice content—including but not limited to voice content transmitted over a telecommunications network in the context of a multiparty conversation.

Certain examples of related to this technique are now explained in terms of exemplary use scenarios. After presentation of the use scenarios, various embodiments of the present invention will be described with reference to flow-charts and block diagrams. It is noted that the use scenarios relate to the specific case where the advertisements are presented ‘visually’ by the client device. In other examples, audio advertisements may be presented—for example, before, during or following a call or conversation.

Also, it is noted that the present use scenarios and many other examples relate to the case where the multi-party conversation is transmitted via a telecommunications network (e.g. circuit switched and/or packet switched). In another example, two or more people are conversing ‘in the same room’ and the conversation is recorded by a single microphones or plurality of microphones (and optionally one or more cameras) deployed ‘locally’ without any need for transmitting content of the conversation via a telecommunications network.

In the following examples, certain personality properties for a given user are detected from electronic media content of a multi-party conversation, and advertisements are targeted to one or more individuals associated with the ‘given user’ in accordance with the computed personality profiles.

As will be discussed with later figures, it is often useful to provide a service to advertisers (or those wishing to place ads) where the advertiser and/or ad-placer can specify how to which user personalities to target a given ad and/or how to target a given ad to different personalities. Furthermore, it may be useful, for example, to price service where the advertisement is distributed in accordance with the various personality profiles.

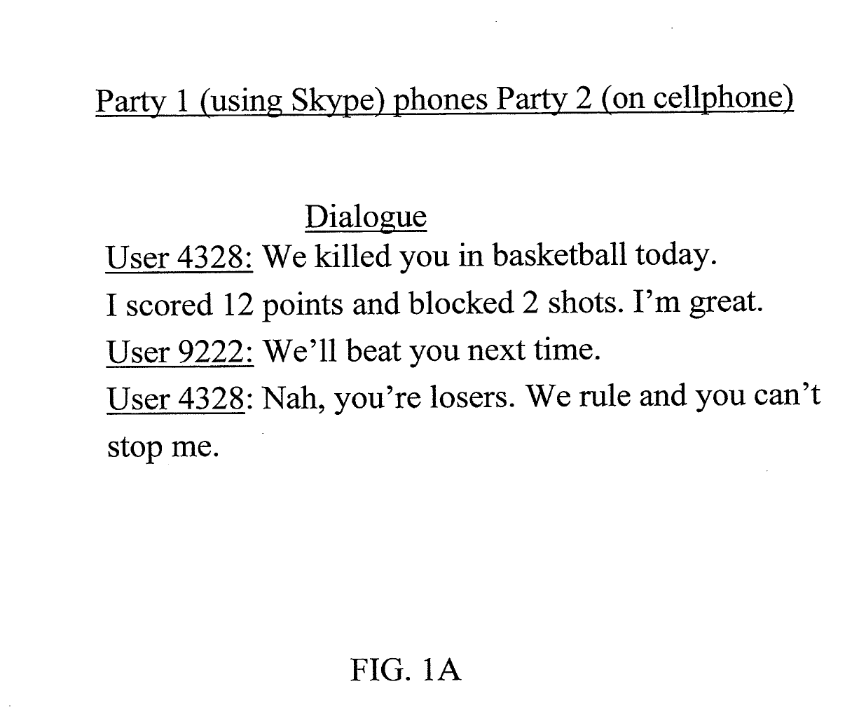

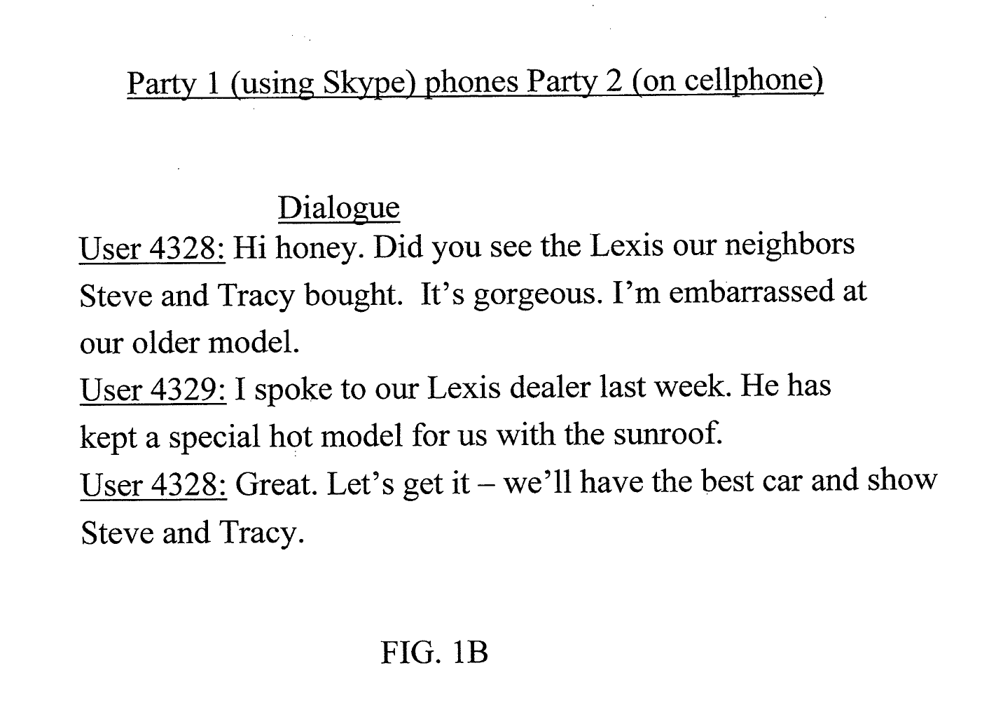

### Use Scenario 1 (Example of FIG. 1A-1B)

### Detecting a “Competitive” Personality from Electronic Media Content

According to this scenario, a first user (i.e. ‘party 1’) of a desktop computer phones a second user (i.e. ‘party 2’) cellular telephone using VOIP software residing on the desktop, such as Skype® software in two distinct conversations: conversation a first conversation (FIG. 1A) and a second conversation (FIG. 1B). Over the course of one or more ‘eavesdropped’ conversations, it is possible to generate a personality profile for a given user in accordance with one or more features detected from the electronic media content of the conversation(s) (i.e. audio and/or video electronic media).

According to the example of FIGS. 1A-1B, it is determined that User 4328 is likely to be a ‘competitive person’ from the verbal content of the conversation. In particular, key phrases like “we killed you”; “you're losers”; “you can't stop me” in the conversation of FIG. 1A and “we'll have the best” in the conversation of FIG. 1B indicates that, indeed, User 4328 does appear to have a ‘competitive personality.’

It is appreciated that FIGS. 1A-1B provide a simplified example and there may be many cases where it is possible that a given user that is not a generally competitive person says speaks one or more of the aforementioned phrases. For example, it is known that ‘average people’ may speak competitively to each other about sporting events.

Thus, in some embodiments, it is advantageous to track the media content generated by a given user or speaker over multiple conversations in order to more accurately assess one or more personality characteristics of a personality profile for the given user or speaker.

In some embodiments, is hypothesized that if properties indicative of a ‘competitive’ personality are detected (i.e. from electronic media content of multi-party conversations) for a given user over time and/or in multiple conversations and/or in different situations, then the user is more likely to have a ‘competitive’ personality. Conversely, it is recognized that if these properties are only detected rarely and/or only in certain situations (for example, ‘competitive’ situations where the ‘baseline’ even for ‘non-competitive people is competitive—for example, sport-discussions), then it is less likely that the given user has the ‘competitive’ personality.

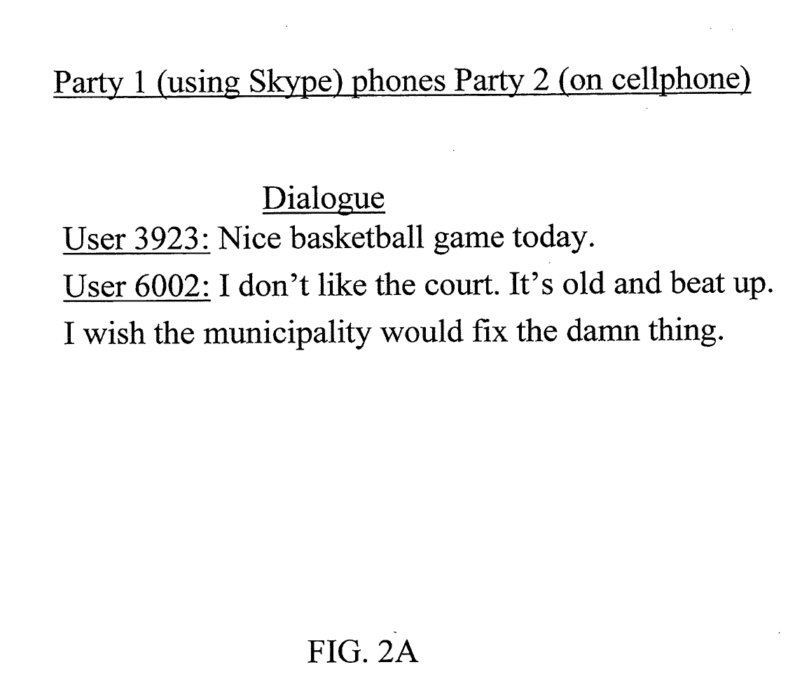

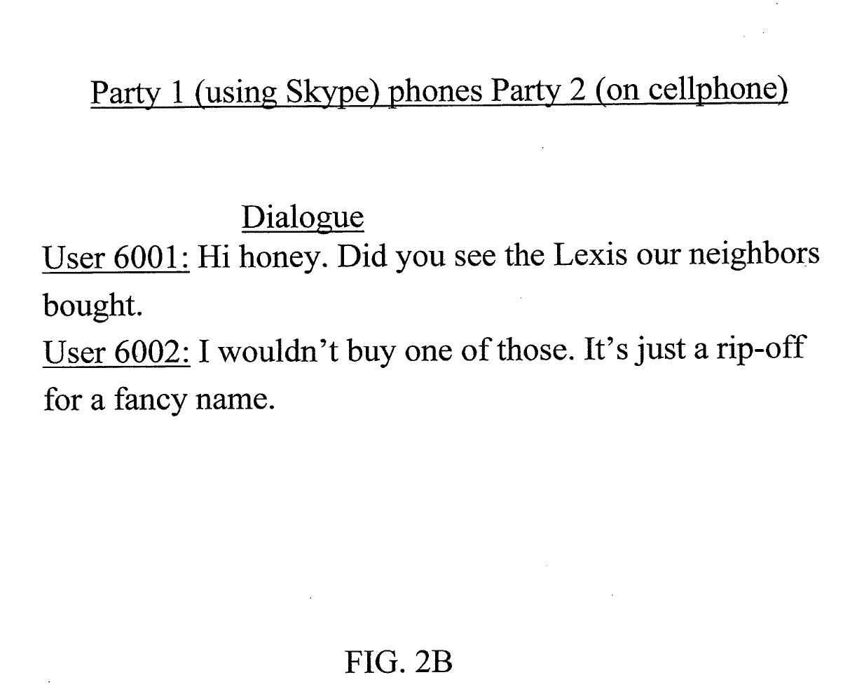

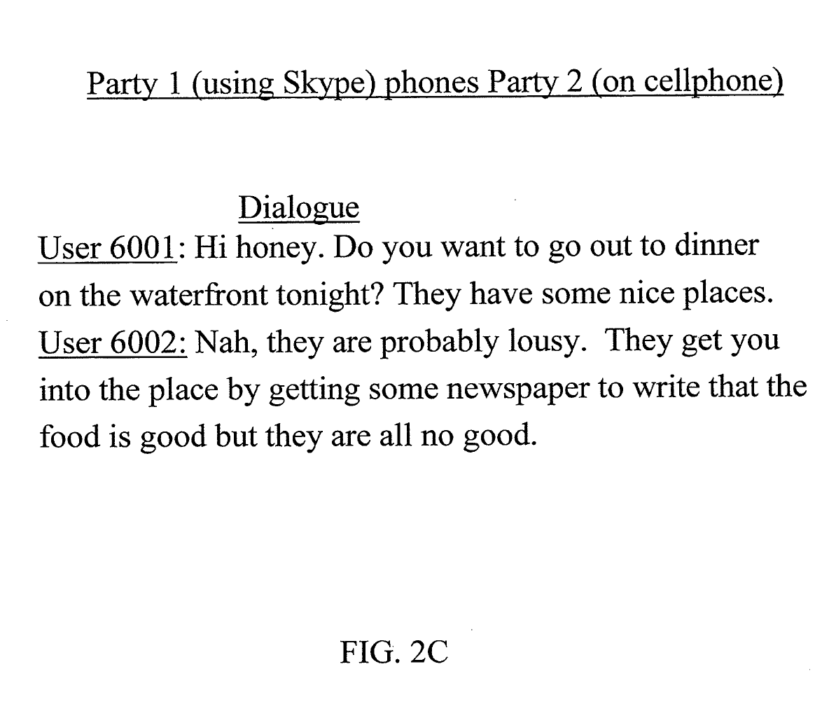

### Use Scenario 2 (Example of FIG. 2A-2B)

### Detecting a “Complainer” Personality (i.e. a Person with a Propensity to Complain) from Electronic Media Content

According to this scenario, a first user (i.e. ‘party 1’) of a desktop computer phones a second user (i.e. ‘party 2’) cellular telephone using VOIP software residing on the desktop, such as Skype® software in two distinct conversations: conversation a first conversation (FIG. 2A) and a second conversation (FIG. 2B). Over the course of one or more ‘eavesdropped’ conversations, it is possible to generate a personality profile for a given user in accordance with one or more features detected from the electronic media content of the conversation(s) (i.e. audio and/or video electronic media).

According to the example of FIGS. 2A-2B, it is determined that User 6002 is likely to be a ‘complainer’ from the negative language—i.e. “don't”; “beat up”; “wouldn't buy”; “rip-off.”

In one example, certain products or services may specifically be targeted to complainers. In another example, complainers are less likely to purchase certain products or services, so advertisement is targeted to all users except for those with a personality profile that includes ‘complainer.’

It is noted that FIGS. 2A-2B relates to the specific case of detecting a ‘complaining personality’ from the verbal content of the digital media content. This is certainly not a limitation, and other techniques for detecting the ‘complainer’ personality may entail detecting body-language of the speaker/user (for example, see if the person slouches or gets agitated when saying a certain statement), facial expressions, and/or the tone or voice quality of the speaker.

### Use Scenario 3 (Example of FIG. 3A-31B)

### Detecting a “Optimist” Personality from Electronic Media Content

According to this scenario, a first user (i.e. ‘party 1’) of a desktop computer phones a second user (i.e. ‘party 2’) cellular telephone using VOIP software residing on the desktop, such as Skype® (software in two distinct conversations: conversation a first conversation (FIG. 3A) and a second conversation (FIG. 3B). Over the course of one or more ‘eavesdropped’ conversations, it is possible to generate a personality profile for a given user in accordance with one or more features detected from the electronic media content of the conversation(s) (i.e. audio and/or video electronic media).

According to the example of FIGS. 3A-3B, it is determined that User 832 is likely to be an ‘optimist’ from his reaction to phrases of co-conversationalists. Thus, in FIG. 3A, when user User 1922 says something indicative of ‘bad news,’ User 832 reacts with the optimistic phrase “don't worry about it.” In FIG. 3B, once again, user 832 reacts to ‘bad news’ (i.e. related to the report card—this may be detected as ‘bad news’ by the presence of the word ‘terrible’) verbalized by a co-conversationalist with optimistic comments (i.e. “much better,” “things'll work out”).

In the example of FIGS. 3A-3B, the personality profile is generated only in accordance with verbal content; as noted earlier, this is not a limitation, and other features including but not limited to sound features and video features may be used.

### A Non-Limiting List of Exemplary Personality Traits

The aforementioned examples list to very specific personality traits, namely “competitiveness” (see FIGS. 1A-1B); “complainer/tendency to complain” (see FIGS. 2A-2B); and “optimist” (see FIGS. 3A-3B).

Below is a non-limiting list of various personality traits, each of which may be detected for a given speaker or speakers—in accordance with one or more personality traits, advertisement may be provided. In the list below, certain personality traits are contrasted with their opposite, though it is understood that this is not intended as a limitation.

a) Ambitious vs. Lazy
b) Passive vs. active
c) passionate vs. dispassionate
d) selfish vs. selfless
e) Norm Abiding vs. Adventurous
f) Creative or not
g) Risk averse vs. Risk taking
h) Optimist vs Pessimist
i) introvert vs. extrovert
j) thinking vs feeling
k) image conscious or not
l) impulsive or not
m) gregarious/anti-social
n) addictions—food, alcohol, drugs, sex
o) contemplative or not
p) intellectual or not
q) bossy or not
r) hedonistic or not
s) fear-prone or not
t) neat or sloppy
u) honest vs. untruthful

In some embodiments, individual speakers are given a numerical ‘score’ indicating a propensity to exhibiting a given personality trait. Alternatively or additionally, individual speakers are given a ‘score’ indicating a lack of exhibiting a given personality trait.

### A Brief Discussion of Exemplary Techniques for Detecting Personality Traits

As noted above, presence or absence of ‘key words’ is just one exemplary technique for detecting a presence or absence of a given personality trait in a given speaker. In certain examples as shown with reference to FIGS. 1-3, it is possible that when a speaker says certain ‘key words’ in response to certain events (for example, in response to other key words spoken by a co-conversationalist, in response to certain visual events such as ‘body language,’ in response to background sounds, etc).

Thus, in one example related to video conferencing, the appearance of a dog may make a certain person draw back in fear, indicating that this individual is fear-prone.

In another example related to video conferencing, a person's appearance may indicate if the person is neat or sloppy.

### Some Brief Definitions

As used herein, ‘providing’ of media or media content includes one or more of the following: (i) receiving the media content (for example, at a server cluster comprising at least one cluster, for example, operative to analyze the media content and/or at a proxy); (ii) sending the media content; (iii) generating the media content (for example, carried out at a client device such as a cell phone and/or PC); (iv) intercepting; and (v) handling media content, for example, on the client device, on a proxy or server.

As used herein, a ‘multi-party’ voice conversation includes two or more parties, for example, where each party communicated using a respective client device including but not limited to desktop, laptop, cell-phone, and personal digital assistant (PDA).

In one example, the electronic media content from the multi-party conversation is provided from a single client device (for example, a single cell phone or desktop). In another example, the media from the multi-party conversation includes content from different client devices.

Similarly, in one example, the media electronic media content from the multi-party conversation is from a single speaker or a single user. Alternatively, in another example, the media electronic media content from the multi-party conversation is from multiple speakers.

The electronic media content may be provided as streaming content. For example, streaming audio (and optionally video) content may be intercepted, for example, as transmitted a telecommunications network (for example, a packet switched or circuit switched network). Thus, in some embodiments, the conversation is monitored on an ongoing basis during a certain time period.

Alternatively or additionally, the electronic media content is pre-stored content, for example, stored in any combination of volatile and non-volatile memory.

As used herein, ‘providing at least one advertisement in accordance with a least one personality feature and/or a personality profile detectable from media content includes one or more of the following:

i) configuring a client device (i.e. a screen of a client device) to display advertisement such that display of the client device displays advertisement in accordance with the detectable at least one personality feature of the media content. This configuring may be accomplished, for example, by displaying a advertising message using an email client and/or a web browser and/or any other client residing on the client device; ii) sending or directing or targeting an advertisement to a client device in accordance with the at least one detectable personality feature of the media content (for example, from a client to a server, via an email message, an SMS or any other method);

iii) configuring an advertisement targeting database that indicates how or to whom or when advertisements should be sent, for example, using ‘snail mail to a targeted user—i.e. in this case the database is a mailing list.

Embodiments of the present invention relate to providing or targeting advertisement to an ‘one individual associated with a party of the multi-party voice conversation.’

In one example, this individual is actually a participant in the multi-party voice conversation. Thus, a user may be associated with a client device (for example, a desktop or cellphone) for speaking and participating in the multi-party conversation. According to this example, the user's client device is configured to present (i.e. display and or play audio content) the targeted advertisement.

In another example, the advertisement is ‘targeted’ or provided using SMS or email or any other technique. The ‘associated individual’ may thus include one or more of: a) the individual himself/herself; b) a spouse or relative of the individual (for example, as determined using a database); c) any other person for which there is an electronic record associating the other person with the participant in the multi-party conversation (for example, a neighbor as determined from a white pages database, a co-worker as determined from some purchasing ‘discount club’, a member of the same club or church or synagogue, etc).

In one example, a certain personality trait is detected in a given user (for example, the person is ‘impulsive’) from electronic media content of a multi-party conversation, and an advertisement is provided to an associated of the ‘impulsive’ person. This may be, for example, a spouse or a sibling of the impulsive person, even if the ‘associate’ that receives the advertisement does not participate in the multi-party conversation from which the ‘impulsive’ personality trait is detected.

Detailed Description of Block Diagrams and Flow Charts

FIG. 4A refers to an exemplary technique for provisioning advertisements.

In step S101, electronic digital media content including spoken or voice content (e.g. of a multi-party audio conversation) is provided—e.g. received and/or intercepted and/or handled.

In step S105, one or more aspects of electronic voice content (for example, content of multi-party audio conversation are analyzed), or context features are computed. Based on the results of the analysis, personality and/or mood traits may be determined.

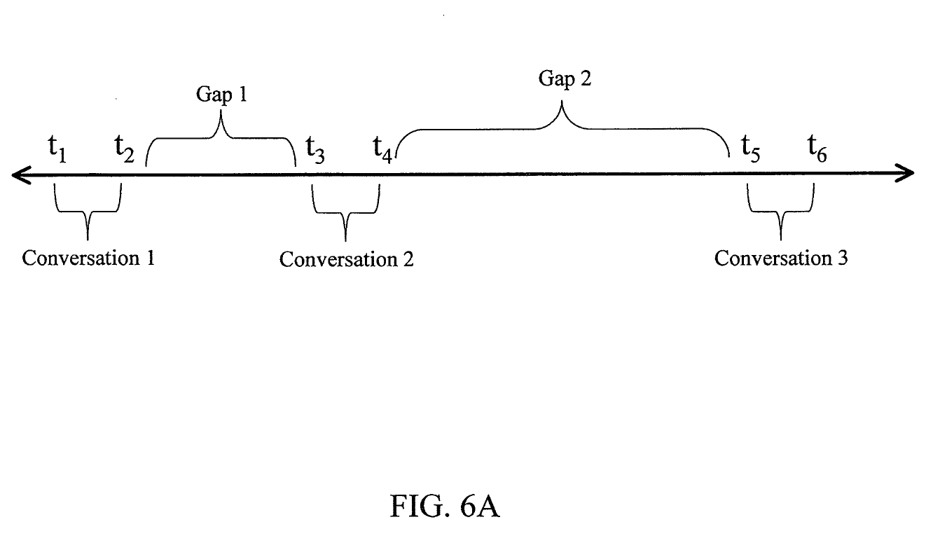

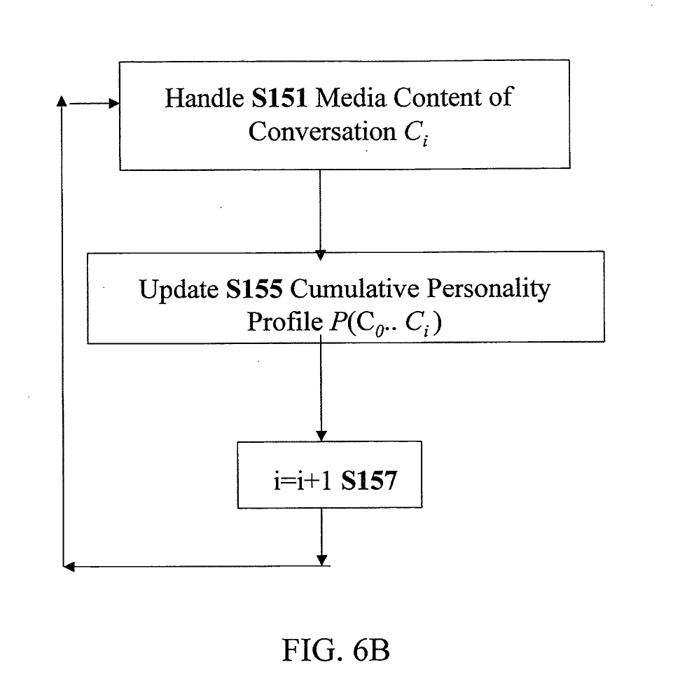

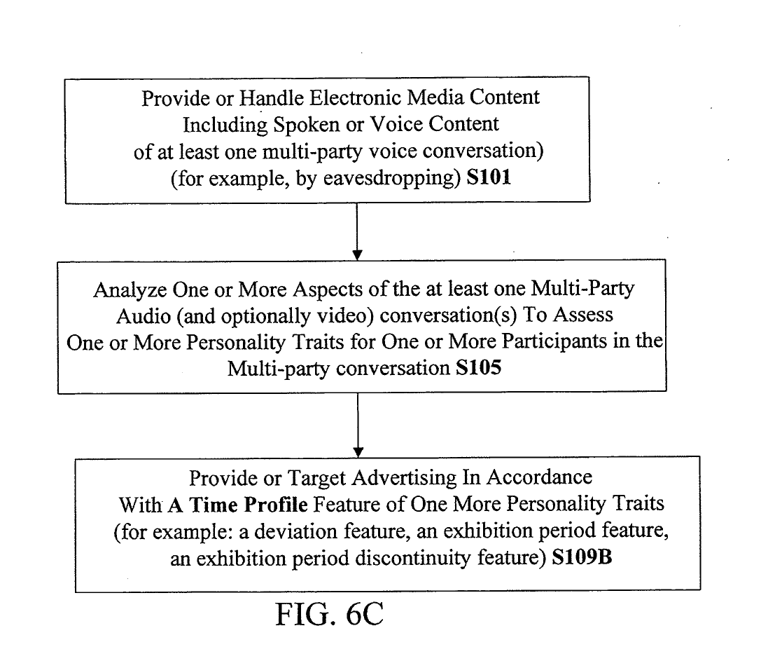

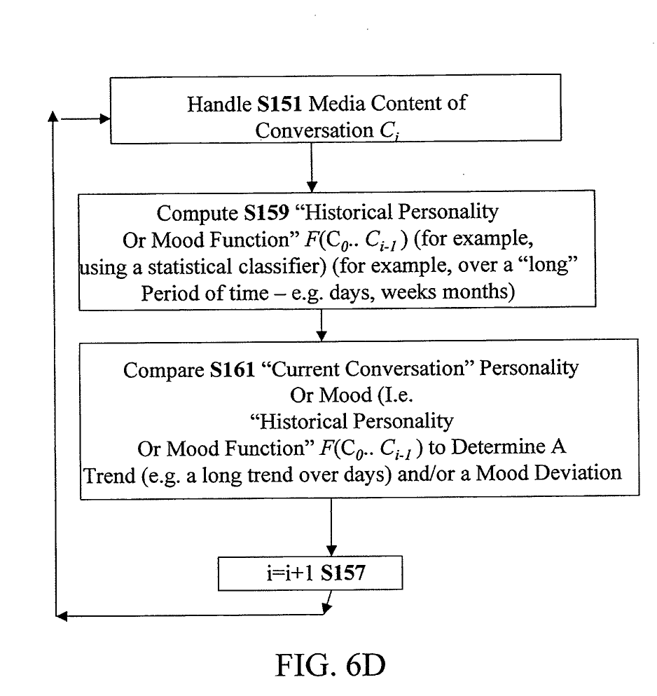

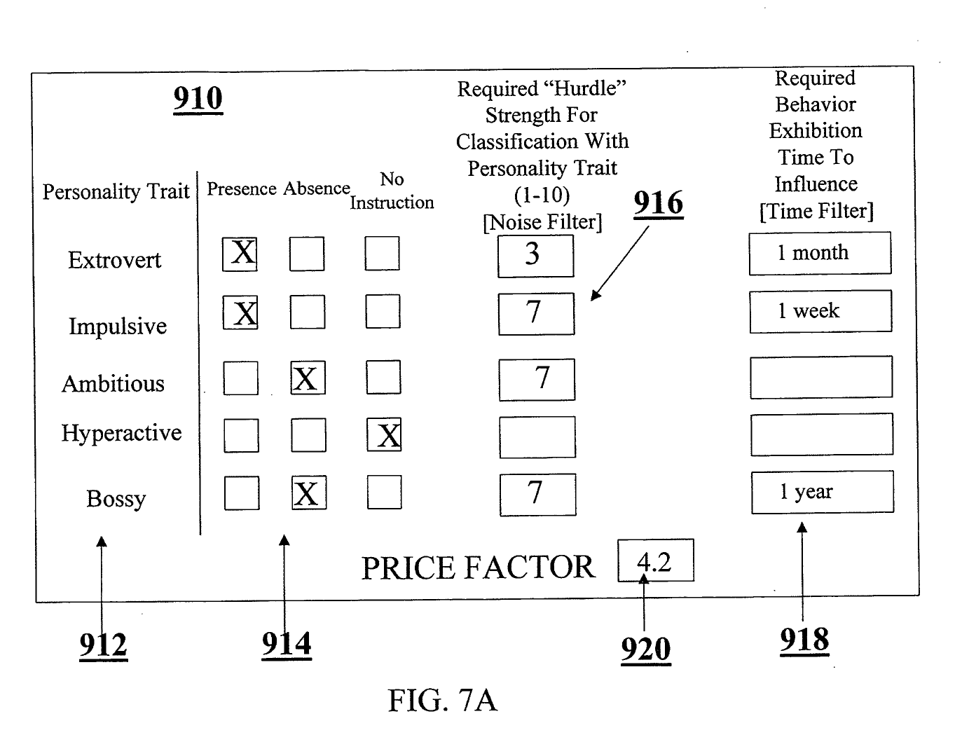

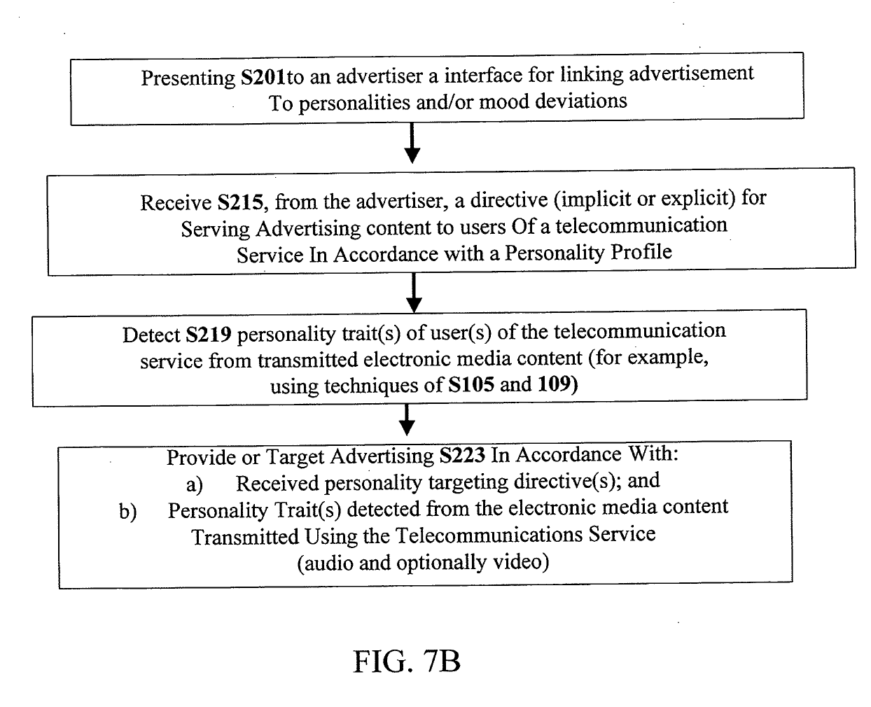

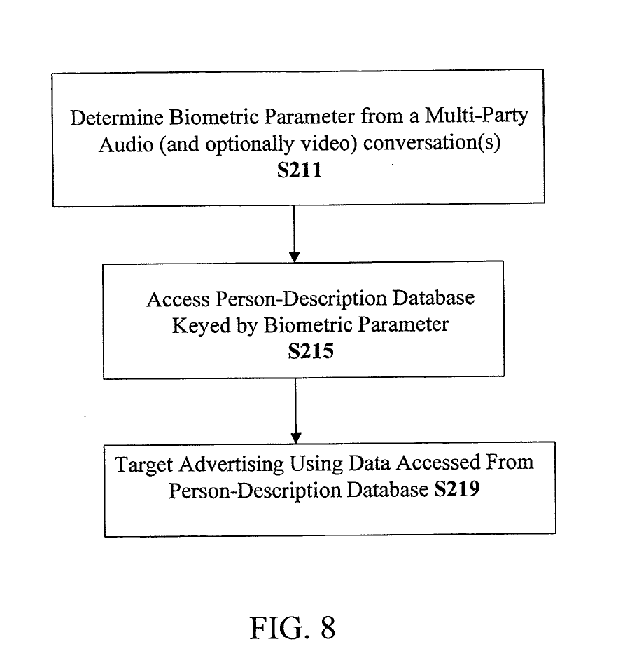

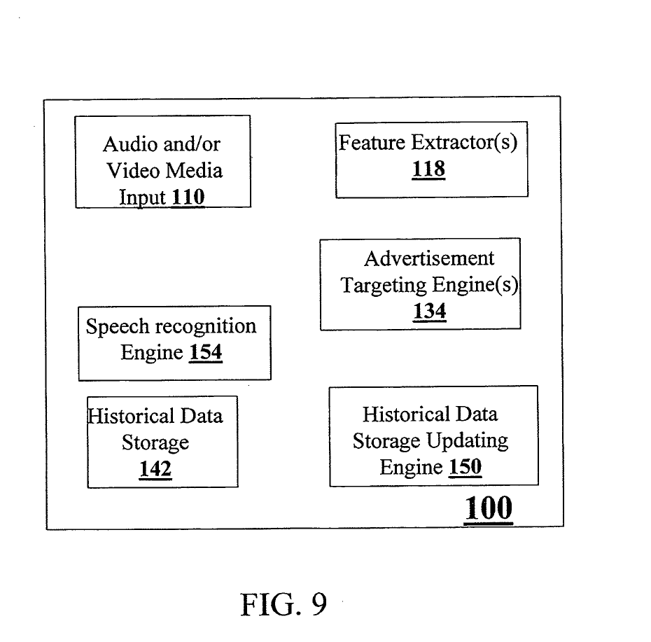

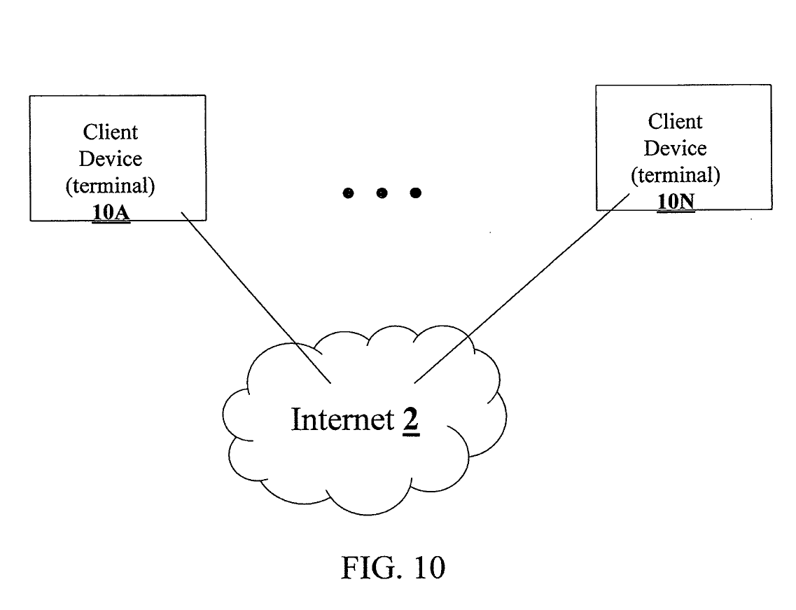

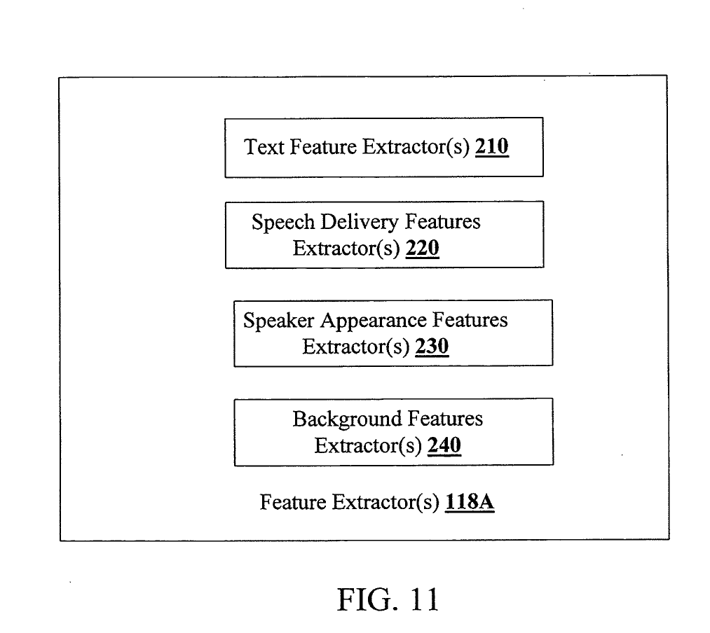

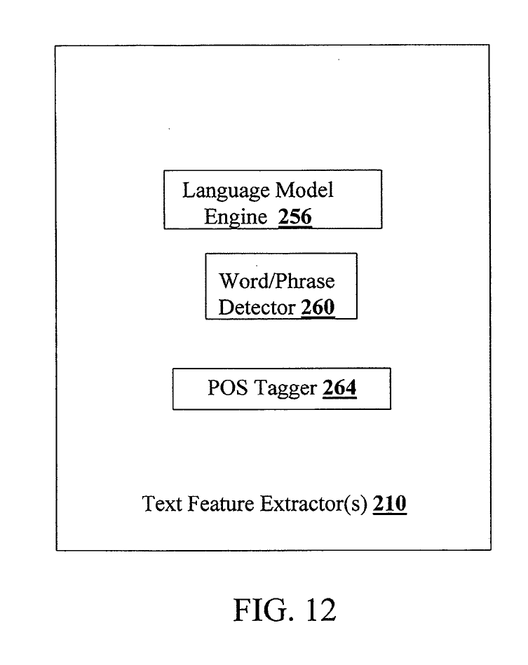

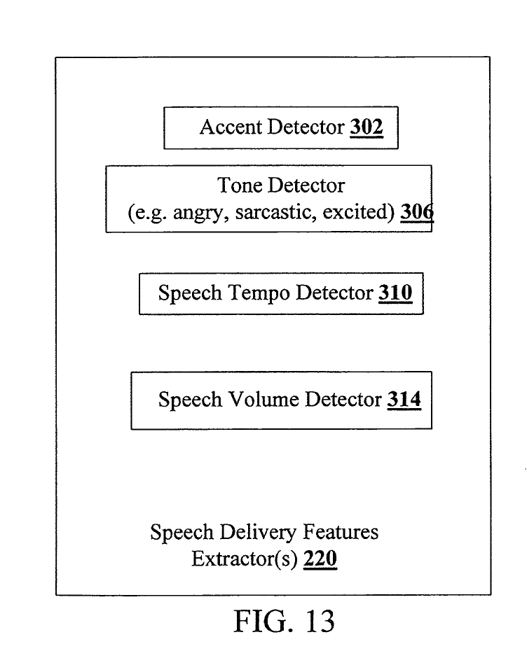

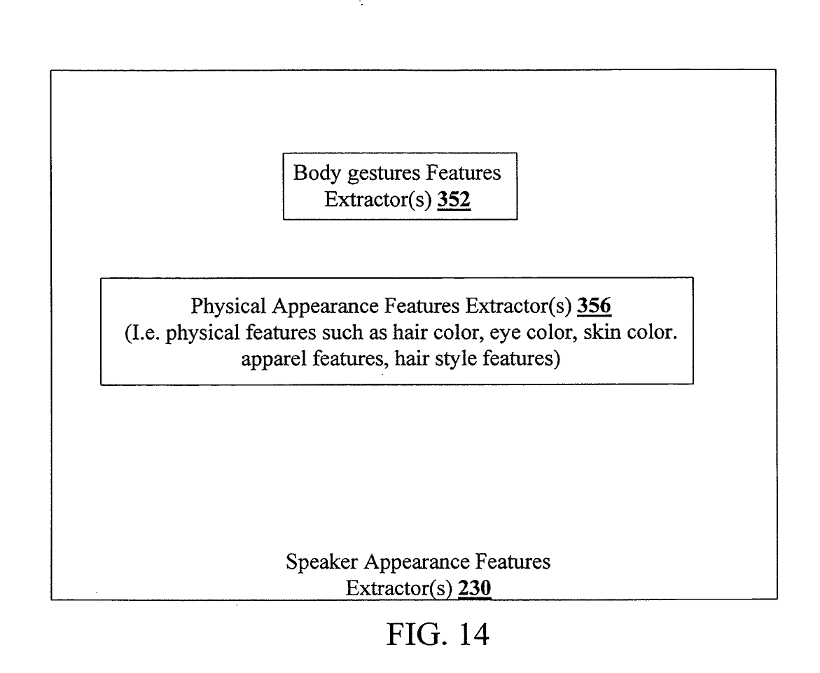

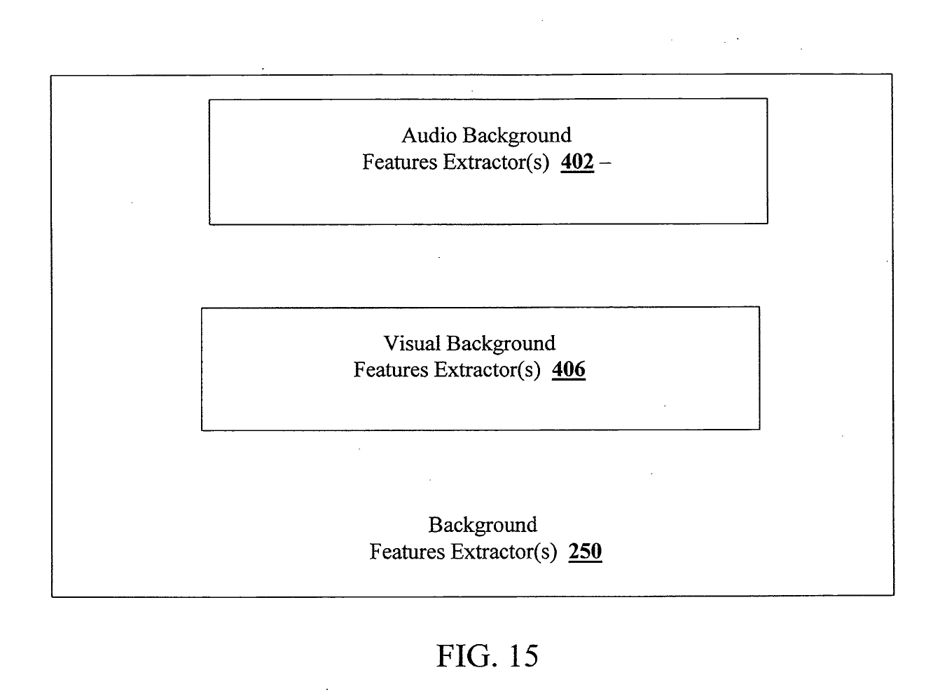

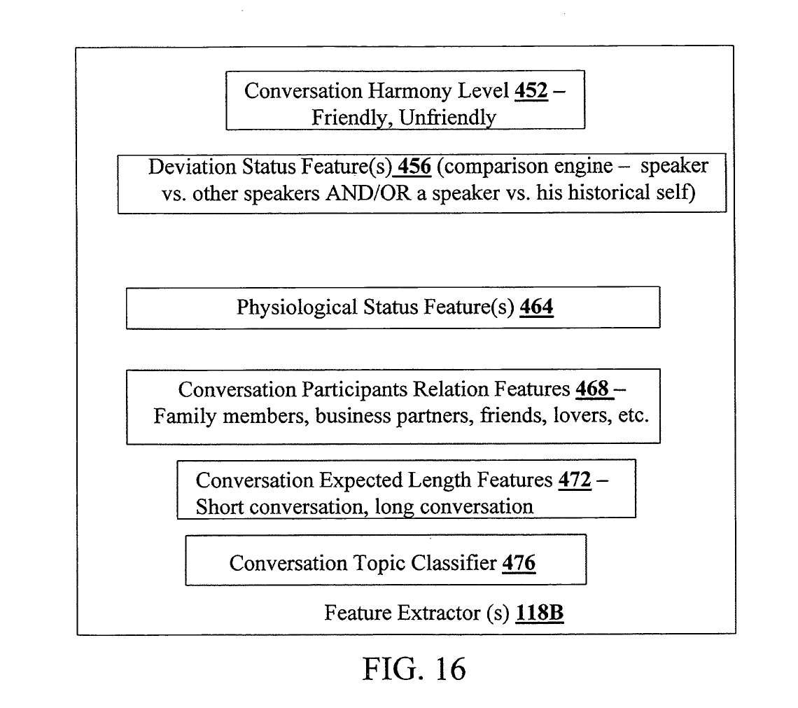

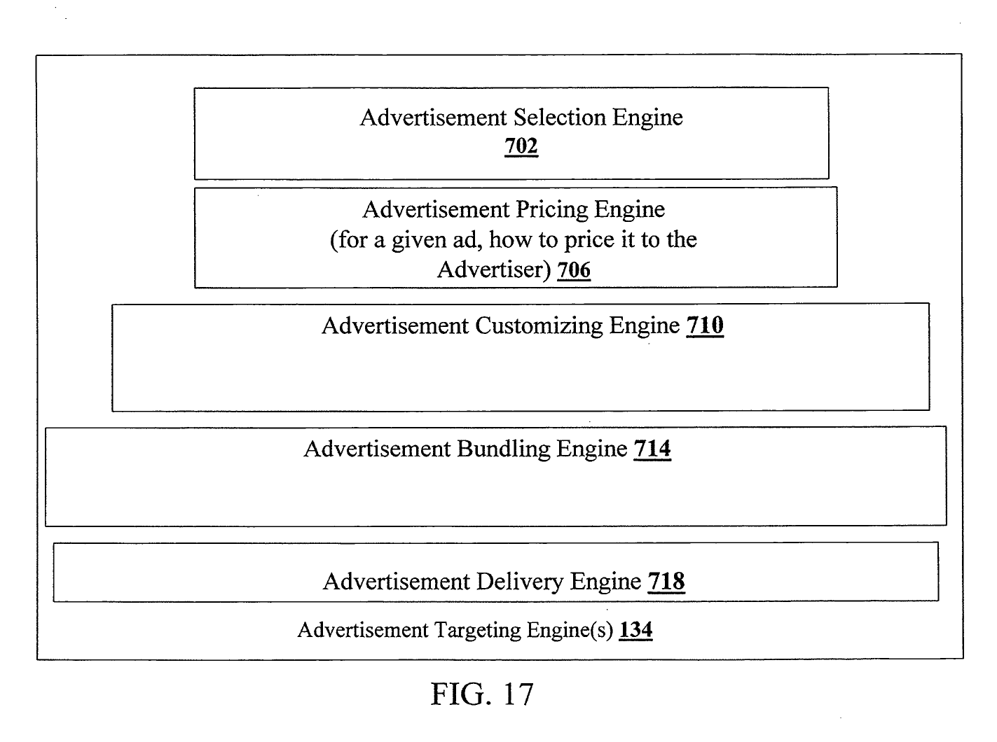

This may be done in any one or more of a number of ways. In one example (see S159 of FIG. 6), certain key words or phrases personality of a personality are detected, in accordance with a present or absence of one or more key words or phrases (or combination thereof). Related examples were discussed with reference to FIGS. 1-3.

In another example, the multi-party conversation is a ‘video conversation’ (i.e. voice plus video). In a specific example, if a conversation participant is dressed in an neat manner or a sloppy manner this may indicate whether or not the person is a perfectionist by nature. In another example, if a conversation participant exhibits certain body motions (for example, constantly shaking his/her knee, constantly pacing, etc) this may indicate a nervous and/or hyperactive disposition.

Other specific examples of specific implementations of step S105 will be discussed below, with reference to other figures.

In step S109, one or more operations are carried out to facilitate provisioning advertising in accordance with results of the analysis of step S105. (as noted throughout this disclosure, there are many examples where multiple conversations are analyzed over a period of time are analyzed in order to better ascertain the personality of a participant in the conversation).

One example of ‘facilitating the provisioning of advertising’ is using an ad server to serve advertisements to a user. Alternatively or additionally, another example of ‘facilitating the provisioning of advertising’ is using an aggregation service. More examples of provisioning advertisement(s) are described below.

It is noted that the aforementioned ‘use scenarios’ related to FIGS. 1-3 provide just a few examples of how to carry out the technique of FIG. 4.

It is also noted that the ‘use scenarios’ relate to the case where a multi-party conversation is monitored on an ongoing basis (i.e. S105 includes monitoring the conversation either in real-time or with some sort of time delay). Alternatively or additionally, the multi-party conversation may be saved in some sort of persistent media, and the conversation may be analyzed S105 ‘off line’.

FIG. 4B provides some more details of one specific implementation of step S105 in accordance with some embodiments of the present invention. Thus, in FIG. 4B, step S105 is broken up into two steps.

In step S121, the media content is analyzed such that person-specific media content is associated with given specific parties. In one example, a VOIP “skype” conversation is analyzed—for example, see FIG. 1A. According to this example, each user terminal Tᵢ (for example, a handset, PC, etc) is associated with a respective person/speaker Pᵢ. According to this example, content originating at terminal T₁ is associated with person P₁, content originating at terminal T₂ is associated with person P₂. In yet another example, a voice recognition and/or face algorithm is employed in order to distinguish between different people.

Once it is determined which visual and/or audio content is generated by which participant, it is possible to associate different content C(P) with respective parties Pᵢ of the conversation.

A Brief Discussion of How to Determine a Presence or Absence of a Personality Trait in a Person

For the present disclosure, “determining” or “generating” a “personality profile” includes determining a presence of at least one personality trait for a given person. In some embodiments, “determining” or “generating” a “personality profile” also includes determining an “absence” of at least one personality trait.

Typically, this is carried out in accordance with a “threshold” certainty for a presence or absence of the personality trait.

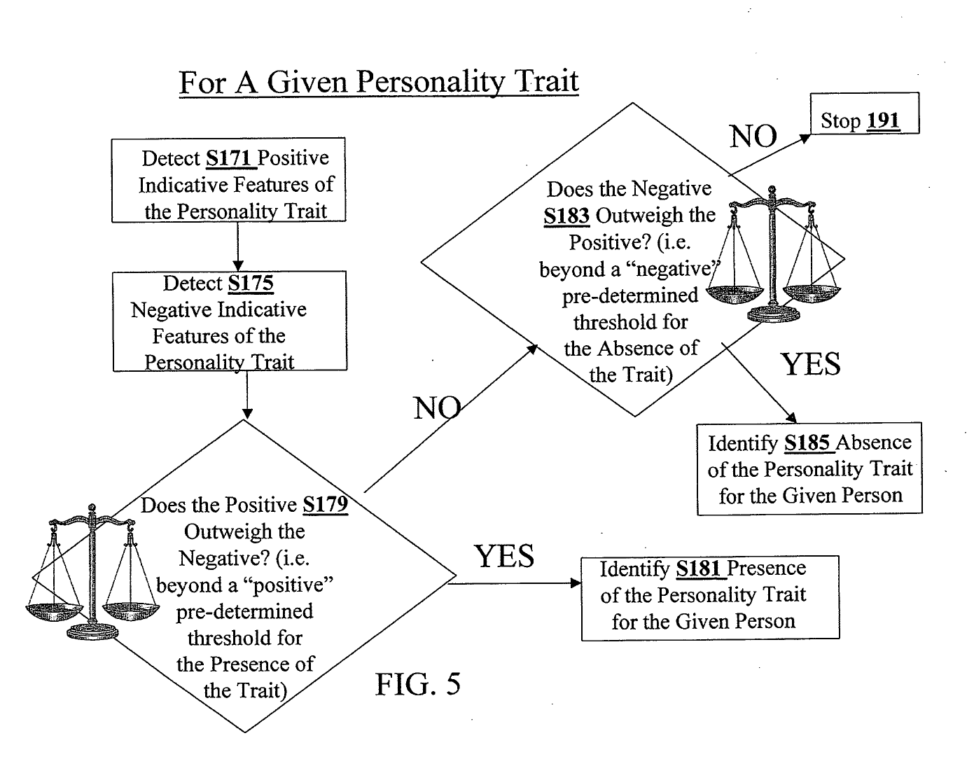

FIG. 5 provides a flowchart of an exemplary routine for determining a personality trait. In step S171, one or more “positive” indicative features are detected for a given personality trait, while in step S175 one or more “negative” indicative features are detected. In one non-limiting example, it is desired to determine if a giving individual is an “extrovert.” In this example, positive indicative features may include talking about oneself, using “large” gestures (i.e. body language), interrupting other speakers when speaking, and talking at a loud volume. “Negative” indicative features may include avoiding eye contact, looking down when speaking, and speaking in “short sentences.”

There are many situations where both “positive indications” as well as “negative indications” are present, and it may be necessary to “weigh” one against the other—for example, using a statistical model. Exemplary statistical models include but are not limited to C45 trees, neural networks, Markov models, linear regression, and the like.

If S179 the “positive” indications outweigh the “negative indications” (i.e. indicating the presence of the personality trait”) for example, according to some statistical model and according to some “threshold” indicative of a statistical significance (for example, established using a training set), the presence of the personality trait in the given person may be identified S181.

If S183 the “negative” indications outweigh the “positive indications” (i.e. indicating the absence of the personality trait”) for example, according to some statistical model and according to some “threshold” indicative of a statistical significance (for example, established using a training set), the absence of the personality trait in the given person may be identified S185.

A Brief Discussion of False Positives and False Negatives

It is noted that there are certain situations where some features “indicative of the presence or absence” of a given personality trait may be detectable, but nevertheless not enough features are present, or too many “contradictory” features (i.e. that contradict a given “present” or “absent” hypothesis) are present for the feature to be considered “present” (or “absent”). This issue has already been discussed with respect to FIG. 5.

Thus, in one oversimplified example, if a person (i.e. a participant in a multi-person conversation—i.e. a potential “target”) exhibits feature “A” (i.e. this is detected in electronic audio and/or video media content generated by the person in the multi-person conversation) there is a 60% chance the “conversation-participant” is “correctly” associated with a given personality trait. If the person exhibits features “A” and “B” the probability is 80%. If the person exhibits features “A,” “B” and “C” but not feature “D” the probability is 90%. If the person exhibits features “A,” “B,” “C” and “D” the probability is 65%.

Thus, it is noted that any model for determining the presence or absence of any given personality trait my be associated with a rate of false positives and false negatives. If we require a “high threshold” (for example, requiring a probability of at least 80% before identifying the presence of personality trait, as in S181 of FIG. 5), then we reduce the number of false positives, while introducing more false negatives. If we lower the “threshold,” for example, to 65%, then we may reduce the number of false negatives (i.e. missed identifications) while paying a price of additional false positives.

In some embodiments, as will be discussed below with reference to element 916 of FIG. 7A, the “hurdle” that must be overcome (i.e. the probability of the hypothesis based upon detected feature) in order for a presence S181 or an absence S185 of a personality trait to be identified may be configurable, for example, by a purchaser of advertisement placement.

A Discussion of Multiple Distinct Conversations and Time Profile Features of One or More Personality Traits

For the present disclosure, video and/or audio media content may be associated with a “time of generation”—i.e. the time the audio and/or visual signals are recorded, for example, during a multi-party voice and optionally video conversation. This “time of generation” may be known within some sort of tolerance—for example, within a few minutes or a few seconds or even less.

FIG. 6A provides a timeline of multiple distinct multi-person conversations—for example, multiple conversations that are transmitted over a communications network—for example, a switching network including but not limited to the Internet. In the example of FIG. 6A, media content from three distinct conversations (e.g. multi-party audio and/or video conversations transmitted over a network) is provided—“conversation 1” which begins at “real” time t₁ and ends at “real” time t₂, “conversation 2” which begins at “real” time t₃ and ends at “real” time t₄, and “conversation 3” which begins at “real” time t₅ and ends at “real” time t₆.

The beginning of a conversation may be defined as: (i) the time an audio and/or video “signal” is provided that a conversation is beginning—for example, a user saying “hi” or “hello”; and/or (ii) for the case of conversations that are transmitted over a switching network (for example, the Internet) between different terminal devices, the time that the audio and/or video stream connection between the different terminal devices residing at different locations over the switching network is established.

Similarly, the “end” of a conversation may be defined as: (i) the time an audio and/or video “signal” is provided that a conversation is ending—for example, a user saying “goodbye”; and/or (ii) for the case of conversations that are transmitted over a switching network (for example, the Internet) between different terminal devices, the time that the audio and/or video stream connection between the different terminal devices residing at different locations over the switching network is terminated.

For the present disclosure, the term “distinct multi-party conversations” (for example, between distinct user terminals of a communications network), refers to conversations where (a) each conversation has a length of at least 30 seconds; (b) the time gap (i.e. see FIG. 6A) between each pair of conversations is at least at least 10 minutes. In some embodiments, the gap time between subsequent conversations is at least 10 times the longer of the two conversations, or at least 100 times the longer of the two conversations.

Some example of “distinct multi-party conversations” include (i) day-separated distinct multi-party conversations (i.e. conversations separated by a gap time of at least 24 hours); (ii) week-separated distinct multi-party conversations (i.e. conversations separated by a gap time of at least 7 days); (iii) month-separated distinct multi-party conversations (i.e. conversations separated by a gap time of at least 1 month).

For the present disclosure, a “long-term time profile” of one or more detected personality traits is either (I) detected separately for at least two distinct multi-party conversations that are at least day-separated multi-party conversations, or possibly week-separated or month-separated (i.e. every conversation individually indicates the presence or absence of the given personality trait beyond some sort of threshold—for example, the technique of FIG. 5 may be applied to each conversation individually); and/or (II) detected cumulatively for at least two distinct multi-party conversations that are at least day-separated multi-party conversations, or possibly week-separated or month-separated (i.e. features are detected S171 and S175 from every conversation of the set of at least two distinct multi-party conversations, and then in accordance with at least one feature from each of the multiple conversations, a presence or absence of the at least one personality (S179 or S183).

This is illustrated in FIG. 6B, where media content of a given “distinct” conversation is handled S151, and in accordance with the media content, a “cumulative” profile S155 is generated from a plurality of distinct conversations, each conversation having an index i.

In some embodiments, “older detected features” (for example, associated with a conversation that is “previous” to the “most recent” conversation—for example, an at least day separated or week separated or month separated previous conversation) are given less weight (i.e. when categorizing a person has having a presence or absence of one or more personality features) in accordance with the “age” of the conversation—i.e. media content of a “newer” conversation is given greater weight when determining one or more personality features of a given person.

FIG. 6C provides a flowchart of an exemplary technique for handling the targeting of advertising in accordance with personality analysis. In the example of FIG. 6C, digital media content is analyzed S105 and advertising is targeted S109B in accordance with a time profile feature of one or more personality traits. In some embodiments, this may be a “trend personality feature”—either a “short term trend” for example, within a single distinct conversation, or a “long-term trend feature” indicating how user's personality or mood has changed between distinct conversations—for example, day-separated, week separated or month-separated distinct conversations.

In one example, it may be decided to target people who historically are introverted, but who recently have become extroverted.

In another example, it may be decided to target people who, typically over a period of time, are introverted, but are having an “extroverted day” or react to a certain person in an extroverted manner.

Mood Deviations

For the present disclosure a “mood deviation” refers to the difference between the mood of an individual (for example, a participant in a multi-party conversation) (i) at a point in time, or during a given time interval (for example, a “short interval” of less than 30 minutes, or less than 10 minutes) and (ii) the person's historical moods or exhibited personality traits, for example, as observed in an earlier and

In one example, it is desired to target individuals who typically are introverted or soft-spoken at a time that they exhibit a period of extroversion or agitation, or some mood which contrasts a typical historical personality.

Each of determining the “current mood” as well as historical “personality traits” may carried out using some sort of statistical classifier model, for example, a configurable classifier model for minimizing false negatives or false positives.

FIG. 6D provides a flow chart of an exemplary technique for computing a mood deviation and/or a personality trend function. For at least one “historical” conversation (for example, at least day separated or at least week separated or at least month separated from a most recent conversation), a historical personality or mood function is computed S159.

Digital media content of a most recent or “current” conversation is analyzied to determine a presence or absence of a mood deviation or personality time trend function, for example, using a statistical classifier.

### A Discussion of an Exemplary “Personality-Advertisement Data-Receiving User Interface

In some embodiments, it is advantageous to market advertising content in accordance with the personality profile of the user (or associated thereof) to whom the advertisement will be served.

For example, it may be determined that in some situations, “risk taking” individuals are an appropriate target audience. According to this example, a “seller” of electronic advertisement distribution services (or a party or mediator acting on behalf of the “seller”) will offer the “buyer” of such services (or a party acting on behalf of the “buyer”) the option to select a “target audience” in accordance with determined personality of a conversation-participant (i.e. a personality determined, at least in part, from the audio and/or video conversation generated by the conversation-participant).

Towards this end, it may, in some embodiments, be useful to provide an interface whereby the “buyer” can specify to a “seller” various directives for provisioning personality-targeted advertisements. One example of such a “personality-advertisement data-receiving user interface” 910 is provided in FIG. 7A. In the example of FIG. 7A, the “buyer” specifies a directive to serve advertisements to extroverted, impulsive, non-ambitious, and non-bossy individuals. It is noted that the interface 910 of FIG. 7A allows for specification of multiple personality traits of a personality profile.

Column 912 allows the user to select which personality features to target. In the example of FIG. 7A, the user representing the “buyer” (for example, a vendor of “relaxed” “fun-oriented” products like Frisbees or has indicated a preference for serving advertisements) wishes to target advertisements for a product or services to extroverted, impulsive individuals who are not bossy.

It is noted that the exemplary “personality-advertisement data-receiving user interface” 910 of FIG. 7A also includes a column 916 where the user can specify the “statistical significance” that must be provided by features or the “hurdle” that must be overcome in order for the presence or absence of a given personality trait to be identified. In the example of FIG. 7A, any integer between 1 and 10 may be specified.

In one business scenario, it is important for a purchaser of advertisement placement services to serve a given advertisement to all individuals having a given personality trait, even if some advertisements are “wrongly” served to individuals with only certain indications (i.e. the purchaser is willing to “suffer” a certain number of false positives in order to minimize false negatives). In this example, the “hurdle” number of column 716 may be set to a relatively low number.

Conversely, in a different business scenario, it is important for a purchaser of advertisement placement services to target advertisement only to individuals that “beyond a doubt” exhibit the personality trait. In this example, the purchaser is willing to “miss” some possible individuals with the trait (i.e. increase more false negatives) while minimizing the number of false positives.

In the example of FIG. 7A, the user (i.e. representing the purchaser) has provided, via the numbers of column 716, a directive that:
a) because of the “low” user-entered value on the first line of column 916 (i.e. equal to “2”), the user representing the “buyer” of advertisement services has specified that the advertisement be provided (for example, to the person for whom the personality trait is detected) such that even a “minor” indication(s) of the extrovert personality trait is enough for a person to be classified as an “extrovert.” This “strategy” indicates a willingness to risk false positives (i.e. those not extroverts classified as extroverts) in order to minimize false negatives (i.e. missed extroverts)
b) because of the “high” user-entered value on the second line of column 916 (i.e. equal to “7”), the user representing the “buyer” of advertisement services has specified that, when providing advertisement in accordance with a detected personality feature, that the conversation-participant only be classified as “impulsive” if there is a high degree of certainty as such—e.g. presence of many or “strong” features, or absence of “negative features,” etc. This “strategy” indicates a desire to avoid false positives even if the risk of false negatives is elevated.

Thus, it is noted that column 916 acts as a “noise filter”—the higher the number, the more “noise” or false positives are filtered out, but at the cost of potentially missing “signal” (i.e. false negatives).

Column 918 of the “personality-advertisement data-receiving user interface” interface 910 includes allows for the user representing the buyer to specify a required “time significance.” Thus, in the example of FIG. 7A, the conversation-participant must exhibit the features indicative of the personality trait (for example, beyond the noise-filter threshold controlled by the value of column 916) for at least one month for the case of “extrovert” and of at least one week for the case of “impulsive.”

It is noted that, in many business scenarios, the fee charged for advertisement placement may be influenced by the personality provide selected and/or the “noise filter” and/or “time filter” values. In the example of FIG. 7A, in accordance with the entered values in the fields of columns 914, 916 and 920, a price factor is computed and provided 920 to the user (i.e. representing the “buyer”).

In one example, the “price factor” is determined such that “more valuable” personality traits (for example, ambitious people) are priced higher. In another example, the “price factor” is determined by supply and demand from various “buyers.”

It is noted that the exemplary “personality-advertisement data-receiving user interface” 910 should not be construed as limiting, and is not a requirement. In some embodiments, the “buyer” and “seller” are represented by machines which neotiate with each other in an “interfaceless” manner, for example, using some data exchange XML or EDI-based protocol.

A Discussion of Various Business Methods

FIG. 7B provides a flow chart of an exemplary technique for: (a) receiving specifications of directives for how to server advertising; and (b) distributing the advertising to individuals associated with conversation-participants of a telecommunications service in accordance with personality traits and/or mood deviations determined from electronic media content transmitted via the telecommunications service.

In step S201, an interface is presented for linking advertisement to personalities (for example, as in 910 of FIG. 7A) and/or mood deviations. In step S215, a directive is received from the “advertiser” or a “buyer” representing the advertiser, to server advertisement content to users of a telecommunications service (or individuals or corporations associated with the users) in accordance with a personality profile or mood deviation, as detected S219 from digital media conversation of the multi-person conversation (for example, by eavesdropping the conversation over the telecommunications network).

In step S223, the advertisement is provided or targeted in accordance with the directives received in step S215 and the detected S219 personality traits or mood deviation functions.

### Storing Biometric Data (for example, Voice-Print Data) and Demograhic Data (with Reference to FIG. 8)

Sometimes it may be convenient to store data about previous conversations and to associate this data with user account information. Thus, the system may determine from a first conversation (or set of conversations) specific data about a given user with a certain level of certainty.

Later, when the user engages in a second multi-party conversation, it may be advantageous to access the earlier-stored demographic data in order to provide to the user the most appropriate advertisement. Thus, there is no need for the system to re-profile the given user.

In another example, the earlier demographic profile may be refined in a later conversation by gathering more ‘input data points.’

In some embodiments, the user may be averse to giving ‘account information’—for example, because there is a desire not to inconvenience the user.

Nevertheless, it may be advantageous to maintain a ‘voice print’ database which would allow identifying a given user from his or her ‘voice print.’

Recognizing an identity of a user from a voice print is known in the art—the skilled artisan is referred to, for example, US 2006/0188076; US 2005/0131706; US 2003/0125944; and US 2002/0152078 each of which is incorporated herein by reference in entirety

Thus, content (i.e. voice content and optionally video content) of a multi-party conversation may be analyzed and one or more biometric parameters or features (for example, voice print or face ‘print’) are computed. The results of the analysis and optionally demographic data are stored and are associated with a user identity and/or voice print data.

During a second conversation, the identity of the user is determined and/or the user is associated with the previous conversation using voice print data based on analysis of voice and/or video content. At this point, the previous personality trait information of the user is available.

Then, the personality trait data may be refined by analyzing the second conversation.

This could allow for determining a personality trait with greater ‘clasification’ certainty (i.e. from ‘cumulative’ of different conversations) and/or determining a personality trait exhibited over a ‘long term’ (for example, at least a day, week or month) which provides a ‘time certainty.’

Discussion of Exemplary Apparatus

FIG. 9 provides a block diagram of an exemplary system 100 for facilitating the provisioning of advertisements in according with some embodiments of the present invention. The apparatus or system, or any component thereof may reside on any location within a computer network (or single computer device)—i.e. on the client terminal device 10, on a server or cluster of servers (not shown), proxy, gateway, etc. Any component may be implemented using any combination of hardware (for example, non-volatile memory, volatile memory, CPUs, computer devices, etc) and/or software—for example, coded in any language including but not limited to machine language, assembler, C, C++, Java, C#, Perl etc.

The exemplary system 100 may an input 110 for receiving one or more digitized audio and/or visual waveforms, a speech recognition engine 154 (for converting a live or recorded speech signal to a sequence of words), one or more feature extractor(s) 118, one or more advertisement targeting engine(s) 134, a historical data storage 142, and a historical data storage updating engine 150.

Exemplary implementations of each of the aforementioned components are described below.

It is appreciated that not every component in FIG. 9 (or any other component described in any figure or in the text of the present disclosure) must be present in every embodiment. Any element in FIG. 9, and any element described in the present disclosure may be implemented as any combination of software and/or hardware. Furthermore, any element in FIG. 9 and any element described in the present disclosure may be either reside on or within a single computer device, or be a distributed over a plurality of devices in a local or wide-area network.

### Audio and/or Video Input 110

In some embodiments, the media input 110 for receiving a digitized waveform is a streaming input. This may be useful for ‘eavesdropping’ on a multi-party conversation in substantially real time. In some embodiments, ‘substantially real time’ refers to refer time with no more than a pre-determined time delay, for example, a delay of at most 15 seconds, or at most 1 minute, or at most 5 minutes, or at most 30 minutes, or at most 60 minutes.

In FIG. 10, a multi-party conversation is conducted using client devices or communication terminals 10 (i.e. N terminals, where N is greater than or equal to two) via the Internet 2. In one example, VOIP software such as Skype® software resides on each terminal 10. In one example, ‘streaming media input’ 110 may reside as a ‘distributed component’ where an input for each party of the multi-party conversation resides on a respective client device 10. Alternatively or additionally, streaming media signal input 110 may reside at least in part ‘in the cloud’ (for example, at one or more servers deployed over wide-area and/or publicly accessible network such as the Internet 20). Thus, according to this implementation, and audio streaming signals and/or video streaming signals of the conversation (and optionally video signals) may be intercepted as they are transmitted over the Internet.

In yet another example, input 110 does not necessarily receive or handle a streaming signal. In one example, stored digital audio and/or video waveforms may be provided stored in non-volatile memory (including but not limited to flash, magnetic and optical media) or in volatile memory.

It is also noted, with reference to FIG. 10, that the multi-party conversation is not required to be a VOIP conversation. In yet another example, two or more parties are speaking to each other in the same room, and this conversation is recorded (for example, using a single microphone, or more than one microphone). In this example, the system 100 may include a ‘voice-print’ identifier (not shown) for determining an identity of a speaking party (or for distinguishing between speech of more than one person).

### In yet another example, at least one communication device is a cellular telephone communicating over a cellular network.

In yet another example, two or more parties may converse over a ‘traditional’ circuit-switched phone network, and the audio sounds may be streamed to advertisement system 100 and/or provided as recording digital media stored in volatile and/or non-volatile memory.

### Feature Extractor(s) 118

FIG. 11 provides a block diagram of several exemplary feature extractor(s)—this is not intended as comprehensive but just to describe a few feature extractor(s). These include: text feature extractor(s) 210 for computing one or more features of the words extracted by speech recognition engine 154 (i.e. features of the words spoken); speech delivery features extractor(s) 220 for determining features of how words are spoken; speaker visual appearance feature extractor(s) 230 (i.e. provided in some embodiments where video as well as audio signals are analyzed); and background features (i.e. relating to background sounds or noises and/or background images).

It is noted that the feature extractors may employ any technique for feature extraction of media content known in the art, including but not limited to heuristically techniques and/or ‘statistical AI’ and/or ‘data mining techniques’ and/or ‘machine learning techniques’ where a training set is first provided to a classifier or feature calculation engine. The training may be supervised or unsupervised.

Exemplary techniques include but are not limited to tree techniques (for example binary trees), regression techniques, Hidden Markov Models, Neural Networks, and meta-techniques such as boosting or bagging. In specific embodiments, this statistical model is created in accordance with previously collected “training” data. In some embodiments, a scoring system is created. In some embodiments, a voting model for combining more than one technique is used.

Appropriate statistical techniques are well known in the art, and are described in a large number of well known sources including, for example, Data Mining: Practical Machine Learning Tools and Techniques with Java Implementations by Ian H. Witten, Eibe Frank; Morgan Kaufmann, October 1999), the entirety of which is herein incorporated by reference.

It is noted that in exemplary embodiments a first feature may be determined in accordance with a different feature, thus facilitating ‘feature combining.’

In some embodiments, one or more feature extractors or calculation engine may be operative to effect one or more ‘classification operations’ for determining a personality trait and/or mood deviation.

Each element described in FIG. 10 is described in further detail below.

Text Feature Extractor(s) 210

FIG. 12 provides a block diagram of exemplary text feature extractors. Thus, certain phrases or expressions spoken by a participant in a conversation may be identified by a phrase detector 260.

In one example, when a speaker uses a certain phrase, this may indicate a current desire or preference. For example, if a speaker says “I am quite angry” this may indicate a mood; if this happens frequently, this may indicate a personality trait—i.e. easily angered.

The speaker profile built from detecting these phrases, and optionally performing statistical analysis, may be useful for present or future provisioning of ads to the speaker or to another person associated with the speaker.

The phrase detector 260 may include, for example, a database of pre-determined words or phrases or regular expressions.

In one example, it is recognized that the computational cost associated with analyzing text to determine the appearance of certain regular phrases (i.e. from a pre-determined set) may increase with the size of the set of phrases.

In some embodiments, it may be useful to analyze frequencies of words (or word combinations) in a given segment of conversation using a language model engine 256.

For example, it is recognized that more educated people tend to use a different set of vocabulary in their speech than less educated people. Thus, it is possible to prepare predetermined conversation ‘training sets’ of more educated people and conversation ‘training sets’ of less educated people. For each training set, frequencies of various words may be computed. For each pre-determined conversation ‘training set,’ a language model of word (or word combination) frequencies may be constructed.

According to this example, when a segment of conversation is analyzed, it is possible (i.e. for a given speaker or speakers) to compare the frequencies of word usage in the analyzed segment of conversation, and to determine if the frequency table more closely matches the training set of more educated people or less educated people, in order to obtain demographic data (i.e. This principle may also be used for different conversation ‘types.’For example, conversations related to computer technologies would tend to provide an elevated frequency for one set of words, romantic conversations would tend to provide an elevated frequency for another set of words, etc. Thus, for different conversation types, or conversation topics, various training sets can be prepared. For a given segment of analyzed conversation, word frequencies (or word combination frequencies) can then be compared with the frequencies of one or more training sets.

The same principle described for word frequencies can also be applied to sentence structures—i.e. certain pre-determined demographic groups or conversation type may be associated with certain sentence structures. Thus, in some embodiments, a part of speech (POS) tagger 264 is provided.

A Discussion of FIGS. 12-17

FIG. 13 provides a block diagram of an exemplary system 220 for detecting one or more speech delivery features. This includes an accent detector 302, tone detector 306, speech tempo detector 310, and speech volume detector 314 (i.e. for detecting loudness or softness.

As with any feature detector or computation engine disclosed herein, speech delivery feature extractor 220 or any component thereof may be pre-trained with ‘training data’ from a training set.

FIG. 14 provides a block diagram of an exemplary system 230 for detecting speaker appearance features—i.e. for video media content for the case where the multi-party conversation includes both voice and video. This includes a body gestures feature extractor(s) 352, and physical appearance features extractor 356.

FIG. 15 provides a block diagram of an exemplary background feature extractor(s) 250. This includes (i) audio background features extractor 402 for extracting various features of background sounds or noise including but not limited to specific sounds or noises such as pet sounds, an indication of background talking, an ambient noise level, a stability of an ambient noise level, etc; and (ii) visual background features extractor 406 which may, for example, identify certain items or features in the room, for example, certain products are brands present in a room.

FIG. 16 provides a block diagram of additional feature extractors 118 for determining one or more features of the electronic media content of the conversations. Certain features may be ‘combined features’ or ‘derived features’ derived from one or more other features.

This includes a conversation harmony level classifier (for example, determining if a conversation is friendly or unfriendly and to what extent) 452, a deviation feature calculation engine 456, a feature engine for demographic feature(s) 460, a feature engine for physiological status 464, a feature engine for conversation participants relation status 468 (for example, family members, business partners, friends, lovers, spouses, etc), conversation expected length classifier 472 (i.e. if the end of the conversation is expected within a ‘short’ period of time, the advertisement providing may be carried out differently than for the situation where the end of the conversation is not expected within a short period of time), conversation topic classifier 476, etc.

FIG. 17 provides a block diagram of exemplary advertisement targeting engine operative to target advertisement in accordance with one or more computed features of the electronic media content. According to the example of FIG. 16, the advertisement targeting engine(s) 134 includes: advertisement selection engine 702 (for example, for deciding which ad to select to target and/or serve—for example, a stock investment product may be selected for an ‘optimist’ while an ad for more conservative money market fund may be selected for a ‘pessimist’); advertisement pricing engine 706 (for example, for determining a price to charge for a served ad to the vendor or mediator who purchased the right to have the ad targeted to a user), advertisement customization engine 710 (for example, for a given book ad will the paperback or hardback ad be sent, etc), advertisement bundling engine 714 (for example, for determining whether or not to bundle serving of ads to several users simultaneously, to bundle provisioning of various advertisements to serve, for example a ‘cola’ ad right after a ‘popcorn’ ad), an advertisement delivery engine 718 (for example for determining the best way to delivery the ad—for example, a teenager many receive an ad via SMS and for a senior citizen a mailing list may be modified).

In another example, advertisement delivery engine 718 may decide a parameter for a delayed provisioning of advertisement—for example, 10 minutes after the conversation, several hours, a day, a week, etc.

In another example, the ad may be served in the context of a computer gaming environment. For example, games may speak when engaged in a multi-player computer game, and advertisements may be served in a manner that is integrated in the game environment. In one example, for a computer basketball game, the court or ball may be provisioned with certain ads determined in accordance with the content of the voice and/or video content of the conversation between games.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

All references cited herein are incorporated by reference in their entirety. Citation of a reference does not constitute an admission that the reference is prior art.

The articles “a” and “an” are used herein to refer to one or to more than one (i.e., to at least one) of the grammatical object of the article. By way of example, “an element” means one element or more than one element.

The term “including” is used herein to mean, and is used interchangeably with, the phrase “including but not limited” to.

The term “or” is used herein to mean, and is used interchangeably with, the term “and/or,” unless context clearly indicates otherwise.

### The term “such as” is used herein to mean, and is used interchangeably, with the phrase “such as but not limited to”.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

What is claimed is:

1) A method of facilitating advertising, the method comprising:
a) providing electronic media content of at least one multi-party voice conversation; and
b) in accordance with a personality profile for a given conversation party, indicated by said electronic media content, providing at least one advertisement.

2) The method of claim 1 wherein said personality-profile-dependent providing is contingent on a positive feature set of at least one feature of said electronic media content for said personality profile, outweighing a negative feature set of at least one feature of said electronic media content for said personality profile, according to a training set classifier model.

3) The method of claim 2 wherein at least one said feature of at least one of said positive and said negative feature set is a video content feature.

4) The method of claim 2 wherein at least one said feature of at least one of said positive and said negative feature set is a key words feature.

5) The method of claim 2 wherein at least one said feature of at least one of said positive and said negative feature set is a speech delivery feature.

6) The method of claim 5 wherein said speech delivery feature is an inter-party speech interruption feature.

7) The method of claim 5 wherein said at least one feature includes at least one speech delivery feature selected from the group consisting of:
i) an accent feature;
ii) a speech tempo feature;
iii) a voice inflection feature;
iv) a voice pitch feature;
v) a voice loudness feature; and
vi) an outburst feature;

8) The method of claim 2 wherein at least one said feature of at least one of said positive and said negative feature set is a physiological parameter feature.

9) The method of claim 8 wherein at least one said physiological parameter is selected from the group consisting of a breathing parameter, a sweat parameter, a coughing parameter, a voice-hoarseness parameter, and a body-twitching parameter.

10) The method of claim 2 wherein at least one feature of at least one of said positive and said negative feature set includes at least one background feature selected from the group consisting of:
i) a background sound feature; and
ii) a background image feature.

11) The method of claim 2 wherein at least one feature of at least one of said positive and said negative feature set includes at least one feature selected from the group consisting of:
i) a speech-delivery feature;
ii) a body-movement feature; and
iii) a physiological parameter feature;

12) The method of claim 2 wherein at least one feature of at least one of said positive and said negative feature set speaker reaction time feature.

13) The method of claim 2 wherein at least one feature of at least one of said positive and said negative feature set if selected from the group consisting of:
i) a typing biometrics feature;
ii) a clicking biometrics feature; and
iii) a mouse biometrics feature.

14) The method of claim 2 wherein at least one said feature of at least one of said positive and said negative feature set is an historical deviation feature.

15) The method of claim 14 wherein at least said historical deviation feature is an intra-conversation historical deviation feature.

16) The method of claim 14 wherein
i) said at least one multi-party voice conversation includes a plurality of distinct conversations;
ii) at least one said historical deviation feature is an inter-conversation historical deviation feature for at least two of said plurality of distinct conversations.

17) The method of claim 14 wherein
i) said at least one multi-party voice conversation includes a plurality of at least day-separated distinct conversations;
ii) at least one said historical deviation feature is an inter-conversation historical deviation feature for at least two of said plurality of at least day-separated distinct conversations.

18) The method of claim 14 wherein at least said historical deviation feature includes at least one speech delivery deviation feature selected from the group consisting of:
i) a voice loudness deviation feature;
ii) a speech rate deviation feature.

19) The method of claim 14 wherein at least said historical deviation feature includes a physiological deviation feature.

20) The method of claim 2 wherein said personality-profile-dependent providing is contingent on a feature set of said electronic media content satisfying a set of criteria associated with said personality profile, wherein:
i) a presence of a first feature of said feature set without a second feature said feature set is insufficient for said electronic media content to be accepted according to said set of criteria for said personality profile;
ii) a presence of said second feature without said first feature is insufficient for said electronic media content to be accepted according to said set of criteria for said personality profile; and
iii) a presence of both said first and second features is sufficient according to said set of criteria.

21) The method of claim 20 wherein:
i) said first feature is a video content feature; and
ii) said second feature is an audio feature.

22) The method of claim 21 wherein said audio feature is a speech delivery feature.

23) The method of claim 21 wherein said audio feature is a key words feature.

24) The method of claim 20 wherein:
i) said first feature is a speech delivery feature.
ii) said second feature is a key words feature.

25) The method of claim 20 wherein
i) said at least one multi-party voice conversation includes a plurality of distinct conversations;
ii) said first feature is a feature is a first said conversation of said plurality of distinct conversations; and
iii) said second feature is a second said conversation of said plurality of distinct conversations.

26) The method of claim 20 wherein
i) said at least one multi-party voice conversation includes a plurality of at least day-separated distinct conversations;
ii) said first feature is a feature is a first said conversation of said plurality of distinct conversations;
iii) said second feature is a second said conversation of said plurality of distinct conversations; and
iv) said first and second conversations are at least day-separated conversations.

27) The method of claim 2 wherein said training set classifier model of said personality profile is a model which accepts or rejects a hypothesis

28) The method of claim 1 wherein said personality-profile-dependent providing is contingent on a feature set of said electronic media content satisfying a set of criteria associated with said personality profile, wherein:
i) a presence of both a first feature of said feature set and a second feature said feature set necessitates said electronic media content being rejected according to said set of criteria for said personality profile; and
ii) a presence of said first feature without said second feature allows said electronic media content to be accepted according to said set of criteria for said personality profile.

29) The method of claim 28 wherein:
i) said first feature is a video content feature; and
ii) said second feature is an audio feature.

30) The method of claim 29 wherein said audio feature is a speech delivery feature.

31) The method of claim 29 wherein said audio feature is a key words feature.

32) The method of claim 28 wherein:
i) said first feature is a speech delivery feature; and
ii) said second feature is a key words feature.

33) The method of claim 28 wherein
i) said at least one multi-party voice conversation includes a plurality of distinct conversations;
ii) said first feature is a feature is a first said conversation of said plurality of distinct conversations; and
iii) said second feature is a second said conversation of said plurality of distinct conversations.

34) The method of claim 28 wherein
i) said at least one multi-party voice conversation includes a plurality of at least day-separated distinct conversations;
ii) said first feature is a feature is a first said conversation of said plurality of distinct conversations;
iii) said second feature is a second said conversation of said plurality of distinct conversations; and
iv) said first and second conversations are at least day-separated conversations.

35) The method of claim 1 wherein said providing electronic media content includes eavesdropping on a conversation transmitted over a wide-range telecommunication network.

36) The method of claim 1 wherein said personality profile is a long-term personality profile.

37) The method of claim 1 wherein said advertisement-providing is in accordance with a certainty parameter of said personality profile.

38) The method of claim 1 wherein said contingent providing in accordance with said personality profile is contingent on an existence of an indication within said electronic media content that at least one of the following personality-traits conditions is true for said given conversation party:
i) said given conversation party is optimistic;
ii) said given conversation party is ambitious;
iii) said given conversation party is passive;
iv) said given conversation party is selfish;
v) said given conversation party is extroverted;
vi) said given conversation party is creative;
vii) said given conversation party is risk-averse;
viii) said given conversation party is impulsive;
ix) said given conversation party is bossy;
x) said given conversation party is sloppy;
xi) said given conversation party is self-confident; and
xii) said given conversation party is honest.

39) The method of claim 1 wherein said personality-profile-dependent-advertisement-providing includes selecting an advertisement from a pre-determined pool of advertisements in accordance with said personality-profile.

40) The method of claim 1 wherein said personality-profile-dependent-advertisement-providing includes customizing a pre-determined advertisement in accordance with said personality profile.

41) The method of claim 1 wherein said personality-profile-dependent-advertisement-providing includes modifying an advertisement mailing list in accordance with said personality profile.

42) The method of claim 1 wherein personality-profile-dependent-advertisement-providing includes configuring a client device to present at least one said advertisement in accordance with said personality profile.

43) The method of claim 1 wherein personality-profile-dependent-advertisement-providing includes determining an ad residence time in accordance with said personality profile.

44) The method of claim 1 wherein said personality-profile-dependent-advertisement-providing includes determining an ad switching rate in accordance with said personality profile.

45) The method of claim 1 wherein said personality-profile-dependent-advertisement-providing includes determining an ad size parameter rate in accordance with said personality profile.

46) The method of claim 1 wherein said personality-profile-dependent-advertisement-providing includes presenting at least one acquisition condition parameter whose value is determined in accordance with said personality profile.

47) The method of claim 1 wherein said at least one acquisition condition parameter is selected from the group consisting of:
i) a price parameter and
ii) an offered-item time-interval parameter.

48) The method of claim 1 further comprising:
c) receiving a specification of said personality-profile; and
d) receiving a certainty parameter associated with said personality-profile,
wherein said personality-profile-dependent-advertisement-providing is carried out in accordance with said certainty parameter.

49) A method of facilitating advertising, the method comprising:
a) providing electronic media content of at least one multi-party voice conversation; and
b) in accordance with a personality-trait-exhibition-incident occurrence-frequency for a given conversation party, indicated by said electronic media content, providing at least one advertisement.

50) A method of facilitating advertising, the method comprising:
a) providing electronic media content of at least one multi-party voice conversation; and
b) in accordance with a mood deviation for a given conversation party, indicated by said electronic media content, providing at least one advertisement.

51) An apparatus useful for facilitating advertising, the apparatus comprising:
a) a data storage operative to store electronic media content of a multi-party voice conversation including spoken content of said conversation; and
b) a data presentation interface operative to present at least one advertisement in accordance with a personality profile for a given conversation party, indicated by said electronic media content.

52) An apparatus useful for facilitating advertising, the apparatus comprising:
a) a data storage operative to store electronic media content of a multi-party voice conversation including spoken content of said conversation; and
b) a data presentation interface operative to present at least one advertisement in accordance with a personality-trait-exhibition-incident occurrence-frequency for a given conversation party, indicated by said electronic media content

53) An apparatus useful for facilitating advertising, the apparatus comprising:
a) a data storage operative to store electronic media content of a multi-party voice conversation including spoken content of said conversation; and
b) a data presentation interface operative to present at least one advertisement in accordance with a mood deviation for a given conversation party, indicated by said electronic media content

54) A method of facilitating advertising, the method comprising:
a) receiving a directive to distribute advertisement content to users of a telecommunications service where a plurality of users communicate with each other via a telecommunications channel linking said plurality of users, thereby generating electronic media content;
b) providing an advertisement service where said advertisement content is distributed to each user of a plurality of said telecommunications-service users in accordance with a respective personality profile of said each user indicated by respective said telecommunications-channel-communicated electronic media content generated by said each user.

55) The method of claim 54 further comprising:
c) receiving a specification of a said personality profile from a provider of said directive to distribute advertisement content.

56) The method of claim 54 further comprising:
c) receiving a specification of at least one personality-trait certainty profile associated with said personality profile, wherein said personality-profile-dependent providing is carried out in accordance with said personality-trait certainty parameter.

57) The method of claim 54 further comprising:
c) pricing advertisement distribution of said advertisement service in accordance with said personality profile.
